(19) United States
(12) Patent Application Publication
(10) Pub. No.: US 2014/0067428 A1
(43) Pub. Date: Mar. 6, 2014

(54) APPARATUS, METHOD AND ARTICLE TO PROVIDE AN INSURANCE WORKFLOW MANAGEMENT SYSTEM

(71) Applicants: Eric William Snyder, Sammamish, WA (US); Lloyd Sutton Hawes, II, Seattle, WA (US); Hon Seng Long, Redmond, WA (US)

(72) Inventors: Eric William Snyder, Sammamish, WA (US); Lloyd Sutton Hawes, II, Seattle, WA (US); Hon Seng Long, Redmond, WA (US)

(73) Assignee: VERTAFORE, INC., Bothell, WA (US)

(21) Appl. No.: 13/598,297

(22) Filed: Aug. 29, 2012

(51) Int. Cl. G06Q 40/08; G06Q 10/06

(52) U.S. Cl. 705/4

(57) ABSTRACT

Systems and methods automate and manage the workflow within the insurance industry, including the development of line of business task lists and task scheduling for insurance agents, insurance brokers, insurance underwriters, and insurance carriers. Tasks are selected based on a selected line of business and due dates for each task are determined based times allocated precedent to an engagement due date or subsequent to a task list creation date.

### BACKGROUND

1. Technical Field

The present disclosure generally relates to systems and methods for developing a workflow management system to provide one or more insurance services by an insurance professional.

2. Description of the Related Art

The insurance industry typically includes a variety of entities which cooperate to provide various types of insurance products or policies. Entities are typically grouped into three principal types, based on their respective roles: 1) insurance carriers or underwriters, 2) insurance agencies or brokerages with their associated agents or brokers, and 3) consumers, policyholders or insureds. Each of these entities may be of various sizes, from individuals to large businesses (e.g., tens or hundreds of thousands of employees).

Insurance carriers or underwriters, commonly referred to as insurers, underwrite the risk or eventuality that is being insured against. The insurers are typically relatively large companies, with deep financial resources. Insurers may include publicly or privately held companies or alternatively mutual companies (i.e., owned by policyholders). Insurers may be for profit or not for profit companies. Insurers often are classified based on the type of insurance they underwrite. The two fundamental classifications are life insurance companies and non-life, general or property/casualty insurance companies.

Insurance agencies or brokerages are the public face of the insurers and are responsible for the initial marketing of insurance products to consumers. Insurance agencies or brokerages are typically business entities with one to hundreds or even more agents or brokers. Agencies or agents may in some instances be captive, writing only for one insurer. Alternatively, agencies or brokerages may be independent, writing policies for two more different insurers. Agents or brokers may work directly for the agency or brokerage, as employees, or may work as independent contractors. In some uses, the term agency is used to refer to those entities which owe allegiance to the insurance carrier, underwriter or insurer, while the term brokerage is used to refer to those entities that owe allegiance to the consumer, policyholder or insured.

Agents or brokers typically interact directly with the consumers. Agents or brokers may assist consumers in identifying risks, developing risk management strategies, and selecting amongst various policy options. Policy options may include one or more layers of excess or surplus lines of insurance policies, over and above a primary insurance policy. Agents or brokers may obtain raw data from consumers, complete required forms, and/or solicit one or more insurers to underwrite the policy or policies. The forms are often highly complex, and would be difficult, if not impossible for most consumers to complete unassisted.

Each consumer may have very different insurance requirements from those of other consumers. For example, individual or family consumers or insureds may require relatively simple life, health, disability, automobile, homeowners and/or renters insurance policies. Business consumers or insureds may require relatively simple general insurance policies and/or more complicated insurance policies. Thus a large variety of forms are required to cover the insurance needs of the various types of consumers, from individuals, families, small businesses or other organizations, to very large multi-national companies with disparate operations dispersed across multiple regions and/or countries.

Individual insurers may issue policies only in distinct lines of business. For example, property and casualty lines of business may include: fire, allied lines, farm owners multiple, homeowner's multiple, commercial multiple (i.e., general), commercial lines, mortgage guaranty, ocean marine, inland marine, financial guaranty, medical malpractice, earthquake, group accident and health, credit accident and health, other accident and health, workers compensation, other liabilities, product liability, auto liability, auto physical damage, aircraft, fidelity, surety, glass, burglary and theft, boiler and machinery, credit, and international to name a few. Such may be the result of a level of expertise or comfort of the insurer with a particular type of risk. Such may also be the result of limitations placed on the insurer by various regulatory agencies (e.g., insurance commission) and associated laws and rules. Thus, not all insurers are willing or even capable of underwriting all types of risks.

Fulfilling the requirements of any single consumer may require multiple insurance policies. Each policy may require similar or differing information and may require that information be obtained from the consumer or other third parties (e.g., medical records, driving records, employment records, prior insurance coverage records, and the like).

### BRIEF SUMMARY

Providing insurance products and services to tens, hundreds, or even thousands of consumers presents a daunting logistical task. Providing such products and services in an environment where consumer expectation is set at a level where products and services tailored to their individual circumstances are delivered quickly and at the lowest possible cost increases the complexity of the task facing insurance professionals. Systems and methods to track, improve, and ensure the timeliness of task completion related to the provision of insurance products and services are particularly attractive to insurance professionals such as insurance brokers, agents, and underwriters and ultimately to the carrier itself. Particularly desirable are systems and methods accommodating the specific needs of various consumers, while automating and managing the creation and scheduling of task lists for each of the various policies or lines of business appropriate for each consumer.

Tracking and ensuring the timely collection of information associated with the provision of insurance products and completion of tasks appurtenant thereto is a significant step in meeting a consumer's expectations. The insurance workflow management systems and methods described herein help to facilitate such.

A method of operation of an insurance workflow management system including at least one processor, at least one nontransitory computer-readable medium communicatively coupled to the at least one processor, and a plurality of communications ports may be summarized as including, responsive to the receipt by the insurance workflow management system of an input indicative of a line of business selection, retrieving from the nontransitory computer-readable medium a set of tasks to create a line of business task list, at least a portion of the tasks in the set of tasks related to the provision of one or more insurance services; responsive to the receipt by the insurance workflow management system of an input indicative of an insurance services engagement due date, calculating a respective due date for each task in the set of tasks, each of the respective due dates calculated using a respective time interval allocated for each task; and autonomously generating by the insurance workflow management system an aggregate timeline including a plurality of user selectable icons, each user selectable icon corresponding to a calculated due date having one or more tasks falling thereupon.

The method of claim may further include, responsive to the receipt by the insurance workflow management system of an input indicative of an icon selection input, generating a task summary output for those tasks having calculated due dates corresponding to the selected icon. Calculating a respective due date for each task in the set of tasks may include calculating by the at least one processor the respective due date for each task using the respective time interval defined for the task and extending backwards from the received engagement due date, wherein the respective time interval allocated for the task includes an amount of time precedent to the engagement due date. Calculating a respective due date for each task in the set of tasks may include calculating by the at least one processor a completion date preceding the received engagement due date by a defined number of calendar days; and calculating by the at least one processor the respective due date for each task using the respective time interval defined for the task and extending backwards from the completion date, wherein the respective time interval allocated for the task includes an amount of time precedent to the completion date. Calculating a respective due date for each task in the set of tasks may include calculating by the at least one processor the respective due date for each task using the respective time interval defined for the respective task and extending forward from an engagement creation date, wherein the respective time interval allocated for the task includes an amount of time subsequent to the engagement creation date. The method may further include receiving by the insurance workflow management system an input indicative of at least one new task; logically associating by the insurance workflow management system the at least one new task with the selected line of business; and storing in the nontransitory computer-readable medium the at least one new task and the logical association between the at least one new task and the selected line of business. The method may further include receiving by the insurance workflow management system an input indicative of a party responsible for at least a portion of at least one task in the set of tasks; logically associating by the insurance workflow management system the respective at least one task with the party responsible; and storing in the nontransitory computer-readable medium, the party responsible and the logical association between the respective at least one task and the party responsible. The method may further include receiving by the insurance workflow management system an input indicative of a request to generate a task list output by the party responsible; and generating the task list output including a number of tasks grouped by the party responsible.

An insurance workflow management system for the generation of a line of business task list for the provision of one or more insurance services by an insurance agent, an insurance broker, an insurance underwriter, or an insurance carrier may be summarized as including at least one processor; a plurality of communications ports communicably coupled to the at least one processor; and at least one nontransitory computer-readable medium communicatively coupled to the at least one processor to provide the insurance workflow management system, wherein: in response to an input by at least one of: the insurance agent, the insurance broker, the insurance underwriter, and the insurance carrier, that is indicative of the identification of a line of business, the at least one processor retrieves from the communicably coupled nontransitory computer-readable medium a set of tasks to create a line of business task list that is related to the provision of one or more insurance services; in response to an input by at least one of: the insurance agent, the insurance broker, the insurance underwriter, and the insurance carrier, that is indicative of the identification of an insurance services engagement due date, the at least one processor calculates a respective due date for each task in the retrieved set of tasks, each of the respective due dates calculated using a respective time interval allocated for each task that is retrieved by the at least one processor from the communicably coupled nontransitory computer-readable medium; in response to the calculation of the respective due dates for each of the tasks in the set of tasks, the at least one processor autonomously generates an aggregate timeline including a plurality of user selectable icons, wherein each user selectable icon corresponds to a calculated due date having one or more tasks falling thereupon; and in response to a selection of a user selectable icon by at least one of: the insurance agent, the insurance broker, the insurance underwriter, and the insurance carrier, the at least one processor generates a task summary output including a group of tasks having calculated due dates corresponding to the selected icon.

The respective time interval allocated for the task may include an amount of time precedent to the engagement due date; and wherein the at least one processor calculates the respective due date for each task by extending backwards from the received engagement due date by the amount of time at least equal to the respective time interval allocated for the task. The respective time interval allocated for the task may include an amount of time precedent to a completion date; wherein the at least one processor calculates the completion date by extending backwards a defined number of calendar days from the received engagement due date; and wherein the at least one processor calculates the respective due date for each task by extending backwards from the completion date by the amount of time at least equal to the respective time interval allocated for the task. The respective time interval allocated for the task may include an amount of time subsequent to an engagement creation date; and wherein the at least one processor calculates the respective due date for each task by extending forwards from the engagement creation date by an amount of time at least equal to the respective time interval allocated for the task. In response to the receipt of an input indicative of at least one new task, the at least one processor: may logically associate the at least one new task with the identified line of business; and stores in the nontransitory computer-readable medium the at least one new task and the logical association of the at least one new task with the identified line of business. In response to the receipt of an input indicative of a party responsible for at least a portion of at least one task in the set of tasks, the at least one processor may logically associate the respective task with the party responsible; and store in the nontransitory computer-readable medium the party responsible and the logical association of the respective task with the party responsible. In response to the receipt of an input indicative of a request to generate a task list output by the party responsible, the at least one processor; may autonomously generate a task list output including a number of tasks grouped by the party responsible.

An article of manufacture comprising a non-transitory, computer-readable, storage medium including instructions for an insurance workflow management system that when executed by at least one processor coupled to a non-transitory computer readable medium, may cause the at least one processor to: in response to the receipt by at least one processor of an input indicative of a line of business selection, retrieve from the nontransitory computer-readable medium a set of tasks related to the provision of one or more insurance services; in response to the receipt by the at least one processor of an input indicative of an insurance services engagement due date, calculate a respective due date for each task in the set of tasks, each of the respective due dates calculated using a respective time interval allocated for each task; autonomously generate an aggregate timeline including a plurality of selectable icons, each selectable icon corresponding to one calculated due date having one or more tasks falling thereupon; and in response to the receipt by the at least one processor of an input indicative of an icon selection input, generate a task summary output for those tasks having calculated due dates corresponding to the selected icon. The non-transitory, computer-readable, storage medium may further include instructions that cause the at least one processor to: transmit via the one or more networks communicably coupled to the at least one processor the task summary output to at least one of: an insurance carrier, an insurance underwriter, an insurance broker, or an insurance agent. The non-transitory, computer-readable, storage medium may further include instructions that cause the at least one processor to: calculate the respective due date for each task using the respective time interval allocated for each task and extending backwards from the received engagement due date; wherein the respective time interval allocated for the task includes an amount of time precedent to the engagement due date. The non-transitory, computer-readable, storage medium may further include instructions that cause the at least one processor to: calculate a completion date preceding the received engagement due date a defined number of calendar days; and calculate the respective due date for each task using the respective time interval allocated for each task and extending backwards from the completion date; wherein the respective time interval allocated for the task includes an amount of time precedent to the completion date. The non-transitory, computer-readable, storage medium may further include instructions that cause the at least one processor to: calculate the respective due date for each task using the respective time interval allocated for each task and extending forward from an engagement creation date, wherein the respective time interval allocated for the task includes an amount of time subsequent to the engagement creation date.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a networked insurance industry environment according to one illustrated embodiment, including an insurance management system; a plurality of agencies or brokerages, each with associated devices to provide communications via the insurance workflow management system; and a plurality of insurance companies, underwriters or insurers, each with associated devices to provide communications via the insurance workflow management system, according to one illustrated embodiment.

FIG. 2 is a functional block diagram of an insurance workflow management system networked to an agent or broker operated processor-based device and an insurer underwriter operated processor-based device, according to one illustrated embodiment.

FIG. 3 is a screen print of a user interface particularly illustrating a line of business update interface as used by an insurance industry representative, for example an insurance agent or broker, to establish or modify a set of tasks associated with the lines of business offered by one or more insurers represented by the agent or broker, according to one illustrated embodiment.

FIG. 4 is a screen print of a user interface particularly illustrating a line of business selection provider interface as used by an insurance industry representative, for example an agent or broker, to communicate one or more selected lines of business associated with a particular consumer to one or more insurers represented by the agent or broker, according to one illustrated embodiment.

FIG. 5 is a screen print of a user interface particularly illustrating a line of business selection consumer interface as used by an insurance industry representative, for example an insurance agent or broker, to communicate one or more selected lines of business associated with a particular consumer to one or more consumers, according to one illustrated embodiment.

FIG. 6 is a screen print of a user interface particularly illustrating a provider task interface as used by an insurance industry representative, for example an agent, broker or insurer to view the sets of tasks associated with lines of business offered to one or more consumers and for which the insurance industry representative is at least partially responsible, according to one illustrated embodiment.

FIG. 7 is a screen print of a user interface particularly illustrating a consumer task interface as used by an insurance industry representative, for example an agent, broker or insurer and the consumer to view the sets of tasks associated with lines of business offered to one or more consumers and for which the consumer is at least partially responsible, according to one illustrated embodiment.

FIG. 8 is a screen print of a user interface particularly illustrating a dashboard timeline autonomously generated by the workflow management system and including a timeline having one or more user selectable icons corresponding to one or more task completion dates, according to one illustrated embodiment.

FIG. 9 is a flow diagram showing a high level method of an initial set-up and configuration of an example insurance workflow management system to automate the generation of sets of tasks necessary to provide to a consumer one or more lines of business that are associated with one or more insurance services.

FIG. 10 is a flow diagram showing a high level method of operation of an example insurance workflow management system to automate the generation of sets of tasks necessary to provide to a consumer one or more lines of business that are associated with one or more insurance services.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, server computers, various insurance products or services, insurance industry processes and practices, and communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The terms agency and brokerage, as well as related terms such as agent and broker, are used interchangeably herein, to refer to an entity representing one or more insurers that interacts with the consumer, policyholder or insured.

The terms consumer is used herein to refer to a potential client, consumer, or similar procurer of insurance, as well as to an entity that has an existing insurance policy in place or bound (i.e., policyholder or insured). The terms policyholder and insured are used herein interchangeably to refer to an entity with an existing insurance policy in place or bound.

The terms insurance carriers, insurance company, and insurer are used interchangeably herein to refer one or more entities that underwrite the risk or eventually that is being insured against, by issuance of one or more insurance policies. While the term underwriter is commonly used to refer to a person or business entity that engages in the insurance business, to avoid confusion the term underwriter will be used herein and in the claims to refer to an individual who assesses risks and/or determines premiums in their work for an insurer.

The headings and Abstract of the Disclosure provided herein are for convenience only and do not interpret the scope or meaning of the embodiments.

This disclosure describes various systems, methods and articles related to electronic commerce and in particular evaluation of affiliates in electronic commerce. While specific structures and acts associated with particular illustrated embodiments are disclosed, other structures and acts may be employed in other embodiments.

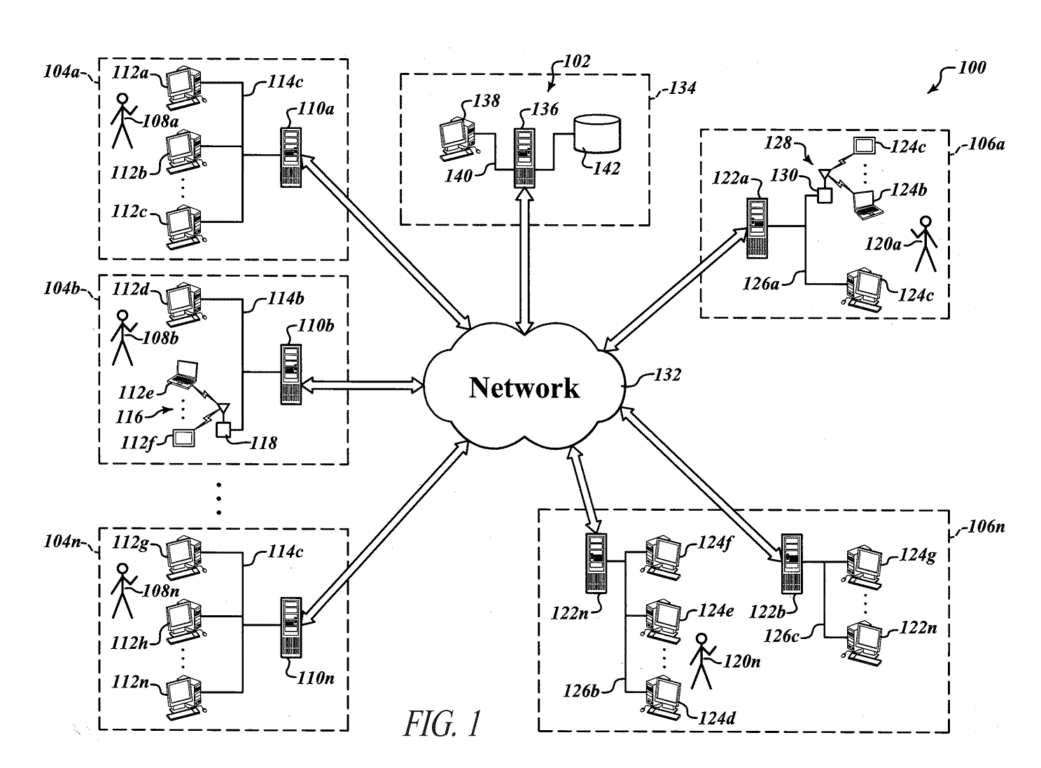

FIG. 1 shows a networked insurance industry environment 100, according to one illustrated embodiment.

The networked insurance industry environment 100 includes an insurance workflow management system 102, a plurality of agencies or brokerages 104a, 104b-104n (three shown, collectively 104), and a plurality of insurance carriers or underwriters 106a-106n (two shown, collectively 106).

The agencies or brokerages 104 may take any variety of forms, for example being of any of a variety of sizes (e.g., one to hundreds of agents or brokers). The agencies or brokerages 104 will typically be independent, that is capable of writing policies underwritten by various ones of the insurers 106. Each agency or brokerage 104 will typically have one or more agents or brokers 108a, 108b-108n (one agent or broker per agency shown, collectively 108). As described in the background section, agents or brokers 108 typically interact directly with the consumer, policyholder or insured (not illustrated).

Each agency or brokerage 104 may have one or more server computers 110a, 110b-110n (only one per agency 104 shown, collectively 110) to provide electronic communications either externally from and/or internally within the agency or brokerage 104. Agencies or brokerages 104 may often have more than one server computer system 110, particularly where the size of the agency or brokerage 104 or the amount of business handled by the agency or brokerage 104 justifies a larger number of server computer systems 110. Each agency or brokerage 104 may have a number of processor-based devices 112a, 112b, 112c, 112d, 112e, 112f, 112g, 112h-112n (three shown per agency 104, collectively 112). The processor-based devices 112 may take a variety of forms which allow input and output by an end user (e.g., agent or broker 108). For example, the processor-based devices may take the form of personal computers 112a-112d, 112g-112n, laptop or notebook computers 112e, tablet computers 112f or other handheld computing devices (not shown in FIG. 1). The processor-based devices 112 may be communicatively coupled to the respective server computers 110 via one or more networks, for example one or more wired (e.g., electrical conductors, optical fibers) networks 114a, 114b-114n (only one per agency or brokerage 104 shown, collectively 114) and/or wireless networks 116 (only one shown) via one or more wireless access points 118 (only one shown).

The insurers 106 may take any variety of forms, typically constituting a relatively large organization. As explained in the background section, each insurer 106 may provide or underwrite insurance policies on some subset of all possible lines of business. Each insurer 106 may typically have one or more underwriters 120a, 120n (one underwriter per insurer 106 shown, collectively 120). The underwriters 120 typically interact directly with the agents or brokers 108, assess risks and/or determine premiums.

Each insurer 106 may have one or more server computers 122a, 122b-122n (three shown, collectively 122) to provide electronic communications either externally from and/or internally within the insurer 106. Given the size of most insurers 106, insurers will typically have more than one server computer system 122. Each insurer 106 may have a number of processor-based devices 124a, 124b, 124c, 124d, 124e, 124f, 124g-124n (eight shown, collectively 124). The processor-based devices 124 may take a variety of forms which allow input and output by an end user (e.g., underwriter 108). For example, the processor-based devices may take the form of personal computers 124a, 124d-124n, laptop or notebook computers 124b, tablet computers 124c, or other handheld computing devices (not shown in FIG. 1). The processor-based devices 124 may be communicatively coupled to the respective server computers 110 via one or more networks, for example one or more wired networks 114a, 114b-114n (only one per insurer 106 shown, collectively 114) and/or wireless networks 128 (only one shown) via one or more wireless access points 130 (only one shown).

The insurance workflow management system 102 operates as an intermediary between the processor-based devices 112 of the agencies or brokerages 104 and the processor-based devices 124 of the insurers 106, electronically communicating over one or more networks, for example over a wide area network 132 such as the Internet or an extranet. The insurance workflow management system 102 may be operated by a separate entity 134 from the agencies or brokerages 104 and insurers 106, ensuring fair access to all parties.

The insurance workflow management system 102 may have one or more server computers 136 (only one illustrated) to provide electronic communications either externally from and/or internally within the entity 134. To handle the load of multiple agencies or brokerages 104 and multiple insurers 106, the insurance workflow management system 102 will typically have more than one server computer system 136. The insurance workflow management system 102 may include one or more terminals or personal computers 138 (only one shown), communicatively coupled to the server computer 136 via one or more wired or wireless networks 140 (only one shown). The terminals or personal computers 138 allow input and output by an end user (e.g., employee or contractor of the entity 134).

The insurance workflow management system 102 includes at least one nontransitory computer- or processor readable storage medium 142. The nontransitory computer- or processor readable storage medium 142 stores a variety of information about the agencies or brokerages 104, agents or brokers 108, insurers 106 and/or underwriters 120, facilitating the automation and management of communications therebetween, including the transmission of electronic correspondence including electronic messages and similar electronic or digital documents.

At times it may be necessary or desirable to share some or all of the electronic or digital documents or files between one or more of the entities (e.g., agencies or brokerages 104, insurers 106, and/or consumers, policyholders or insureds (not shown). Sharing the electronic or digital documents or files may include allowing interactions with such files, for example, viewing, modifying, copying, annotating, importing, and/or deleting. Additionally, or alternatively, it may be desirable to change ownership for one or more of the electronic or digital documents or files. The terms electronic and digital are used interchangeably herein and in the claims. For example, such terms are used to modify the noun “document,” to indicate a set of data that is in a format suitable for use by a processor-based device, for storage in computer- or processor-readable form, or for transmission via a communications network. As used herein and in the claims, the term “document” includes single page or multiple page documents, whether in the form of a text or alphanumeric based binary file (e.g., ASCII, or .doc, .docx, .xlb file extensions), in the form of an image (e.g., binary image, vector based image, Portable Data File or PDF®) of a text, alphanumeric or graphic based document, or in the form of a markup language based file (e.g., HTML, XML).

In some implementations, the nontransitory computer- or processor readable storage medium 142 may constitute a common electronic document repository to store electronic or digital documents or files. As used herein and in the claims, the term “common electronic document repository” means electronic or digital document or file storage media which is shared by two or more networked nodes, such as two or more servers 110, 122 associated with agencies or brokerages 104 and/or insurers 106, and hence is common to at least two network nodes. The common electronic document repository may be implemented in one or across more than one computer- or processor-readable storage media (e.g., write once read many). The common electronic document repository may include one or more databases which state information or data regarding the electronic or digital documents or files. Such database(s) may be stored separately from the electronic or digital documents, for example, on storage medium that may be rewritten many times (e.g., hard drive, RAID, RAM). The common electronic document repository may be co-located with the insurance management system 102, for example in the same room, building or facility. Alternatively, the common electronic document repository may be located remotely from the insurance management system 102, for example in a different facility, city, state or country. Electronic or digital documents or files are collections of information stored at specific locations in non-transitory computer- or processor-readable media, thus are logically addressable portions of such media, which may or may not be contiguous.

While FIG. 1 illustrates a representative networked insurance industry environment, typical networked insurance industry environments may include many additional computer systems and entities. The concepts taught herein may be employed in a similar fashion with more populated networked insurance industry environments.

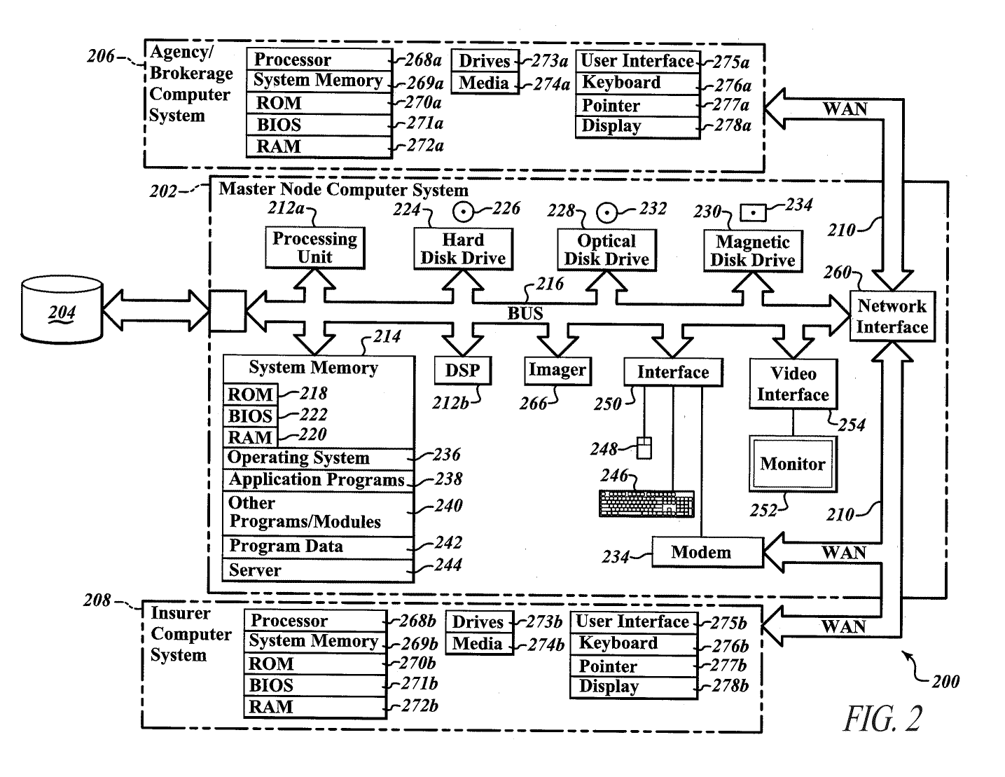

FIG. 2 and the following discussion provide a brief, general description of a suitable networked insurance industry environment 200 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments, as well as other embodiments, can be practiced with other system configurations and/or other computing system configurations, including hand-held devices, multiprocessor systems, microprocessor-based or programmable consumer electronics, personal computers (“PCs”), networked PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices or media.

FIG. 2 shows a networked insurance industry environment 200 comprising one or more insurance management system server computer systems 202 (only one illustrated) and one or more associated nontransitory computer- or processor readable storage medium 204 (only one illustrated). The associated nontransitory computer- or processor readable storage medium 204 is communicatively coupled to the insurance management system server computer system(s) 202 via one or more communications channels, for example one or more parallel cables, serial cables, or wireless channels capable of high speed communications, for instance via an IEEE 1394 FireWire®.

The networked insurance industry environment 200 also comprises one or more agency or brokerage associated computer systems 206 (only one illustrated) and one or more insurance carrier or insurer associated computer systems 208 (only one illustrated). The agency or brokerage associated computer systems 206 and the insurance carrier or insurer associated computer systems 208 are communicatively coupled to the insurance management system server computer system(s) 202 by one or more communications channels, for example one or more wide area networks (WANs) 210, for instance the Internet using Internet protocols. In operation, the agency or brokerage associated computer systems 206 and/or the insurance carrier or insurer associated computer systems 208 typically function as either a server to other end user computer systems (i.e., consumers) associated with a respective entity (e.g., agency, brokerage, insurer) or function as end user computer systems (i.e., consumers) themselves. In operation, the insurance management system server computer system(s) 202 typically functions as a server with respect to the agency or brokerage associated computer systems 206 and/or the insurance carrier or insurer associated computer systems 208.

The networked insurance industry environment 200 may employ other computer systems and network equipment, for example additional servers, proxy servers, firewalls, routers and/or bridges. The insurance management system server computer system(s) 202 will at times be referred to in the singular herein, but this is not intended to limit the embodiments to a single device since in typical embodiments there may be more than one insurance management system server computer system(s) 202 involved. Unless described otherwise, the construction and operation of the various blocks shown in FIG. 2 are of conventional design. As a result, such blocks need not be described in further detail herein, as they will be understood by those skilled in the relevant art.

The insurance management system server computer system(s) 202 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and/or a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the master node server computer system 202, such as during start-up.

The insurance management system server computer system(s) 202 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable media 226, 232, 234, provide nonvolatile storage of computer-readable instructions, data structures, program modules and other data for the master node server computer system 202. Although the depicted insurance management system server computer system(s) 202 is illustrated employing a hard disk 224, optical disk 228 and magnetic disk 230, those skilled in the relevant art will appreciate that other types of computer-readable media that can store data accessible by a computer may be employed, such as WORM drives, RAID drives, magnetic cassettes, flash memory cards, digital video disks (“DVD”), Bernoulli cartridges, RAMs, ROMs, smart cards, etc.

Program modules can be stored in the system memory 214, such as an operating system 236, one or more application programs 238, other programs or modules 240 and program data 242. Application programs 238 may include instructions that cause the processor(s) 212 to automatically store to the associated nontransitory computer- or processor readable storage medium 204 logical relationships between identifiers associated with agents and/or brokers and identifiers associated with selected underwriters of insurers. Application programs 238 may include instructions that cause the processor(s) 212 to automatically control access to certain information based on certain criteria. For example, the instructions may limit agents or brokers from seeing information about a specific underwriter of an insurer, unless the agent or broker has previously identified the specific underwriter.

The application programs 238 may include instructions that cause the processor(s) 212 to associate one or more sets of tasks with the provision of consumer insurance products or services by an insurance agent, broker, or insurer. The application programs 238 may include instructions that cause the processor(s) 212 to assist the insurance agent, broker or insurer in selecting products or services for a particular consumer based upon identified consumer needs.

Responsive to the selection of one or more insurance products, services, or lines of business, the application programs 238 may include instructions that cause the processors(s) 212 to automatically generate a set of tasks for execution to provide a quotation or the indicated product, service, or line or business to the consumer. Such tasks may be automatically selected by the processor(s) 212 based on one or more selection criteria that includes, but is not limited to, the product, service, or line of business, one or more consumer considerations, one or more insurer or underwriter considerations, one or more federal, state or local regulations, one or more insurance industry recommendations, or the like. The application programs 238 may include instructions that cause the processor(s) 212 to facilitate cooperation or collaboration between insurers and insurance brokers and agents, for example through shared sets of tasks related to the provision of one or more consumer insurance products or services that are assigned to the insurer, broker or agent. The application programs 238 may further include instructions that cause the processor(s) 212 to facilitate cooperation or collaboration between the consumer and insurance brokers and agents, for example through one or more shared sets of tasks related to the provision of one or more consumer insurance products or services that are assigned to the consumer, broker, or agent. The application programs 238 may include instructions that cause the processor(s) 212 to automatically generate reports and related correspondence based upon the receipt of task completion data from the various parties assigned to a particular task.

The application programs 238 may further include instructions that cause the processor(s) 212 to automatically send, transmit, transfer, or otherwise provide electronic communications from an agent or broker to a set of underwriters of an insurer based on sets of underwriters defined or identified as affiliated by or with the agent or broker. Such may include sending, transmitting, transferring or otherwise providing access to electronic or digital documents or files including lines of business and sets of tasks associated therewith to the set of underwriters of an insurer defined or identified as affiliated by or with the particular agent or broker. Such may allow an agent or broker to seamlessly automatically distribute electronic communications and documents, for instance a request for a quote on one or more lines of business along with supporting data and/or documentation, to a plurality of different underwriters of insurers with which the agent or broker has an existing defined relationship. Different sets of underwriters may be configured for various specific lines of business which are handled by the respective underwriters or their associated insurers. Thus, an agent or broker may affiliate a first set of underwriters for a first line of business or lines of business, and may affiliate a second set of underwriters for a second line of business or lines of business. Application programs 238 may include instructions that cause the processor(s) 212 to automatically establish, maintain, update or record relationship or affiliation information. Such may include logical relationships between agents or brokers and affiliated underwriters of insurers. Such may include relationships between underwriters and insurers, for instance adding new underwriter as they are hired by an insurer or deleting old underwriters as they leave the employ of the insurer. Such may include relationships between agents or brokers and agencies or brokerages, for instance adding new agents or brokers as they are hired by an agency or brokerage or deleting old agents or brokers as they leave the employ of the agency or brokerage. Such may include updating records, for example task related data in a database or table.

Application programs 238 may include instructions that cause the processor(s) 212 to automatically establish, maintain, update or record ownership information with respect to electronic or digital documents or files, as well as privileges, permissions or authorizations to perform various acts on such electronic or digital documents or files such as reading, modifying, annotating, importing, and/or deleting. Application programs 238 may include instructions that cause the processor(s) 212 to automatically update tasks and create sets of tasks which may or may not be customized to a consumer's specific needs or requests for particular insurance products or services. Application programs 238 may even further include instructions to create entries in and/or query one or more databases which store information or data about agencies, agents or brokers, insurer, underwriters of insurers, or the electronic or digital documents or files, regardless of location at which those electronic or digital documents are stored. Other program modules 240 may include instructions for handling security such as password or other access protection and communications encryption. The system memory 214 may also include communications programs, for example a server 244 that causes the master node server computer system 202 to serve electronic or digital documents or files via corporate intranets, extranets, or other networks as described below. The server 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of suitable severs may be commercially available such as those from Mozilla, Google, Microsoft and Apple Computer.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the management system server computer system(s) 202 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The insurance management system server computer system(s) 202 can include other output devices, such as speakers, printers, etc.

The insurance management system server computer system(s) 202 can operate in a networked environment using logical connections to one or more remote computers and/or devices. For example, the insurance management system server computer system(s) 202 can operate in a networked environment using logical connections to one or more agency or brokerage associated computer systems 206 and the insurance carrier or insurer associated computer systems 208. Communications may be via a wired and/or wireless network architecture, for instance wired and wireless enterprise-wide computer networks, intranets, extranets, and/or the Internet. Other embodiments may include other types of communications networks including telecommunications networks, cellular networks, paging networks, and other mobile networks. There may be any variety of computers, switching devices, routers, bridges, firewalls and other devices in the communications paths between the insurance management system server computer system(s) 202 and the agency or brokerage associated computer systems 206 and the insurance carrier or insurer associated computer systems 208.

The agency or brokerage associated computer systems 206 and the insurance carrier or insurer associated computer systems 208 will typically take the form of end user processor-based devices, for instance personal computers (e.g., desktop or laptop computers), netbook computers, tablet computers and/or smartphones and the like, executing appropriate instructions. These end user processor-based devices may be communicatively coupled to one or more server computers. For instance, agency or brokerage devices may be communicatively coupled externally from the respective agency or brokerage via one or more agency or brokerage server computers, which may implement a firewall. For instance, insurer devices may be communicatively coupled externally from the respective insurer via one or more insurer server computers, which may implement a firewall. The server computers may execute a set of server instructions to function as a server for a number of end user computer systems (i.e., consumers) communicatively coupled via a LAN at a facility or site. The end user computer systems 206, 208 may execute a set of consumer instructions to function as a consumer of the server computer(s), which are communicatively coupled via a WAN.

The agency or brokerage associated computer systems 206 and the insurance carrier or insurer associated computer systems 208 may include one or more processing units 268a, 268b (collectively 268), system memories 269a, 269b (collectively 269) and a system bus (not shown) that couples various system components including the system memory 269 to the processing unit 268. The agency or brokerage associated computer systems 206 and the insurance carrier or insurer associated computer systems 208 will at times each be referred to in the singular herein, but this is not intended to limit the embodiments to a single agency or brokerage associated computer system 206 and/or the insurance carrier or insurer associated computer systems 208. In typical embodiments, there may be more than one agency or brokerage associated computer systems 206 and there will likely be a large number of insurance carrier or insurer associated computer systems 208.

The processing unit 268 may be any logic processing unit, such as one or more central processing units (CPUs), digital signal processors (DSPs), application-specific integrated circuits (ASICs), field programmable gate arrays (FPGAs), etc. Non-limiting examples of commercially available computer systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. Unless described otherwise, the construction and operation of the various blocks of the satellite node server computer systems 206 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270a, 270b (collectively 270) and random access memory (“RAM”) 272a, 272b (collectively 272). A basic input/output system (“BIOS”) 271a, 271b (collectively 271), which can form part of the ROM 270, contains basic routines that help transfer information between elements within the end user computer systems 206, 208, such as during start-up.

The agency or brokerage associated computer systems 206 and the insurance carrier or insurer associated computer systems 208 may also include one or more media drives 273a, 273b (collectively 273), e.g., a hard disk drive, magnetic disk drive, WORM drive, and/or optical disk drive, for reading from and writing to computer-readable storage media 274a, 274b (collectively 274), e.g., hard disk, optical disks, and/or magnetic disks. The computer-readable storage media 274 may, for example, take the form of removable media. For example, hard disks may take the form of a Winchester drives, and optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program modules and other data for the agency or brokerage associated computer systems 206 and/or the insurance carrier or insurer associated computer systems 208. Although described as employing computer-readable storage media 274 such as hard disks, optical disks and magnetic disks, those skilled in the relevant art will appreciate that end user computer systems 206, 208 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, electronic or digital documents or files or data (e.g., metadata, ownership, authorizations) related to such can be stored in the computer-readable storage media 274.

Program modules, such as an operating system, one or more application programs, other programs or modules and program data, can be stored in the system memory 269. Program modules may include instructions for accessing a Website, extranet site or other site or services (e.g., Web services) and associated WebPages, other pages, screens or services hosted by the insurance management system 102. Program modules may include instructions for storing certain or selected electronic correspondence and/or electronic or digital documents or files or changes thereto to nontransitory computer- or processor readable storage medium, such as local media 274a, 274b, or remote media 142 (FIG. 1), 204, 226, 232, 234. Alternatively, the instructions may cause retrieval of electronic correspondence and/or electronic or digital documents or files or changes to existing electronic correspondence and/or electronic or digital documents or files. Program modules may additionally include instructions for handling security such as ownership, password or other access protection and communications encryption.

In particular, the system memory 269 may include communications programs that permit the agency or brokerage associated computer systems 206 and the insurance carrier or insurer associated computer systems 208 to retrieve electronic correspondence and/or electronic or digital documents or files from the associated nontransitory computer- or processor readable storage medium 204. The system memory 269 may additionally include communications programs that permit the agency or brokerage associated computer systems 206 and the insurance carrier or insurer associated computer systems 208 to gain access to or retrieve electronic correspondence and/or electronic or digital documents or files from the local electronic document repository 204 of another satellite node, via the insurance management system server computer system(s) 202, if the requesting agency or brokerage associated computer systems 206 and the insurance carrier or insurer associated computer systems 208 have sufficient right, permission, privilege or authority. The system memory 269 may also include other communications programs, for example a Web consumer or browser that permits the agency or brokerage associated computer systems 206 and the insurance carrier or insurer associated computer systems 208 to access and exchange data with sources such as Web sites of the Internet, corporate intranets, extranets, or other networks. The browser may, for example be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 269, the operating system, application programs, other programs/modules, program data and/or browser can be stored on the computer-readable storage media 274 of the media drive(s) 273. An operator can enter commands and information into the agency or brokerage associated computer systems 206 and the insurance carrier or insurer associated computer systems 208 via a user interface 275a, 275b (collectively 275) through input devices such as a touch screen or keyboard 276a, 276b (collectively 276) and/or a pointing device 277a, 277b (collectively 277) such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278a, 278b (collectively 278) may be coupled to the system bus via a video interface, such as a video adapter. The satellite node server computer system 206 can include other output devices, such as speakers, printers, etc.

As used herein, the term “line of business” refers to one or more lines of business associated with providing one or more insurance services to a consumer. In some, although not all, instances such insurance services can include the establishment or maintenance of one or more indemnity policies in which instance, the consumer may also be referred to as an “insured.” Lines of business are generally offered by insurance carriers or underwriters through a network of dedicated agencies or independent brokerages. Typically, a consumer interfaces with either the dedicated agency or an independent broker to ascertain the need for one or more insurance services, for example by performing a “risk analysis” or similar process. A dedicated agency will serve as the intermediary between the consumer and a single insurer, exchanging data in the form of a set of tasks associated with each particular line of business selected by the agent to meet the needs of the consumer. An independent broker also serves as an intermediary between the consumer and a number of insurers, exchanging data in the form of a set of tasks associated with each particular line of business selected by the agent to meet the needs of the consumer.

The set of tasks generally reflects at least the information considered useful by the insurer when evaluating whether to offer an insurance product or service to a consumer and in determining an appropriate cost or premium for the insurance product or service. Dedicated agencies typically work with a single insurer. The set of tasks associated with a line of business offered through a dedicated agency will therefore be reflective of those factors considered by the insurer and the agency. Independent brokers on the other hand, typically work with multiple insurers. Some or all of the multiple insurers may offer similar lines of business however the factors considered by each insurer may differ. Thus, the set of tasks associated with a particular line of business offered by a dedicated agency may be specific to the information considered useful by the insurer with whom the dedicated agency is affiliated. Alternatively, the set of tasks associated with a particular line of business offered by an independent broker may be more comprehensive in nature and include an aggregation of tasks collecting the information considered useful by all of the insurers who offer appropriate products or services and with whom the independent broker is affiliated. Given the wide variety of situations encountered within the insurance industry, it is advantageous to provide a workflow management system having built in flexibility that is capable of accommodating the needs of insurers, agencies, and brokerages.

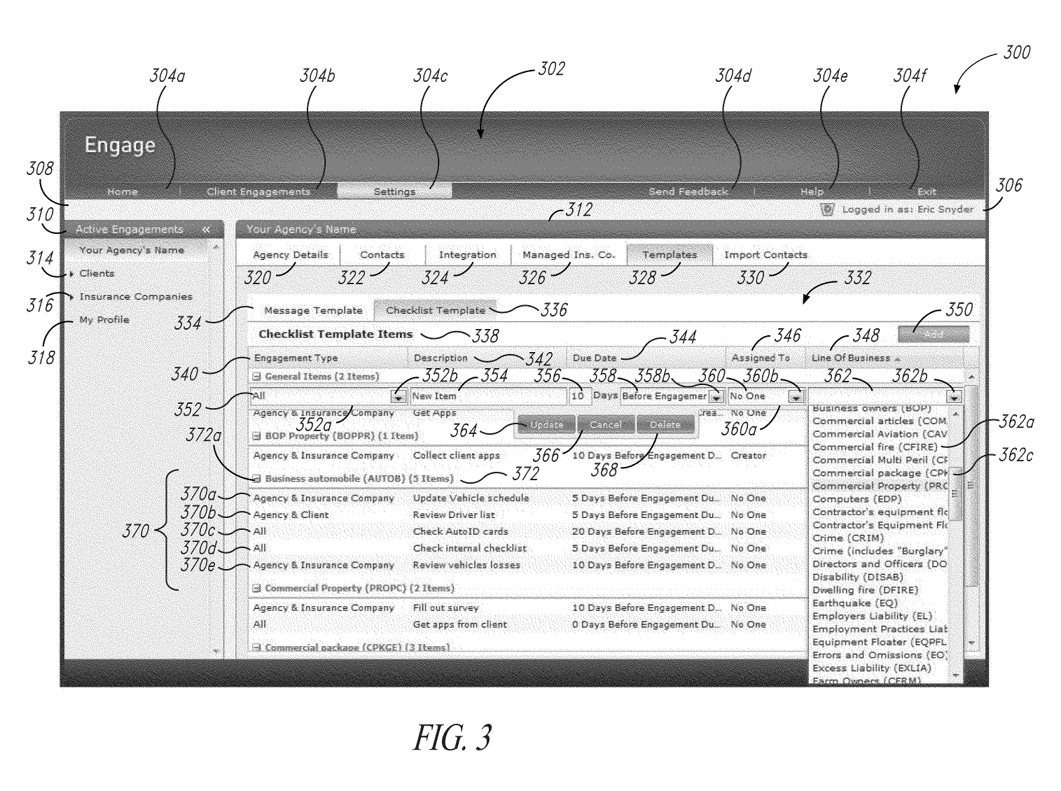

FIG. 3 shows a line of business update interface 300 particularly illustrating a settings panel useful to an insurance agency, brokerage, or insurer in creating or editing one or more tasks in a set of tasks that is associated with the provision of a particular line of business to one or more consumers. The creation or editing of tasks may be undertaken by an agent, a broker, or an insurer responsive to the needs of one or more of the parties. The creation or editing of tasks may occur to reflect changes in the risk assessment method used by the insurer in evaluating a request for insurance services, or to reflect changing market conditions that impact the underlying risk or potential liability associated with a particular insurance product or service offered by the insurer.

The line of business selection provider interface 300 may be presented as a window or screen with a number of user interface components, for instance menus, panels, dialog boxes, radio buttons, expansion controls and plus/minus icons (i.e., icons the selection of which cause a hierarchical list to expand and contract). The terms window and screen are used interchangeably herein to refer to a portion of a user interface (e.g., graphical user interface or GUI), which is displayed on a display or monitor and which provides information (i.e., output) to a user and which may allow the user to provide instructions, commands or information (i.e., input) to a processor-based device or an application executing on a processor-based device.

Various common elements or components appear in the example user interfaces depicted in FIGS. 3-8, with the differences being solely in the content displayed in or by the various components. Thus, identical or similar components are identified with a common reference number across FIGS. 3-8. Only significantly different components are called out with separate reference numbers.

The line of business update interface 300 includes a main menu 302 having a number of user selectable icons or tabs, collectively 304, and a user field 306 that indicates an identity of currently logged-in user. The main menu 302 may include a home tab user selectable icon or tab 304a, consumer or client engagement user selectable icon or tab 304b, settings user selectable icon or tab 304c, send feedback user selectable icon or tab 304d, help user selectable icon or tab 304e, and exit user selectable icon or tab 304f. The user may choose any of the user selectable icon or tabs 304 by selecting the desired user selectable icon or tab with a pointer, for example by manipulating a mouse, trackpad or trackball, touching a touch sensitive display, or tabbing using an appropriate tab key on a keyboard or keypad, or by speaking commands.

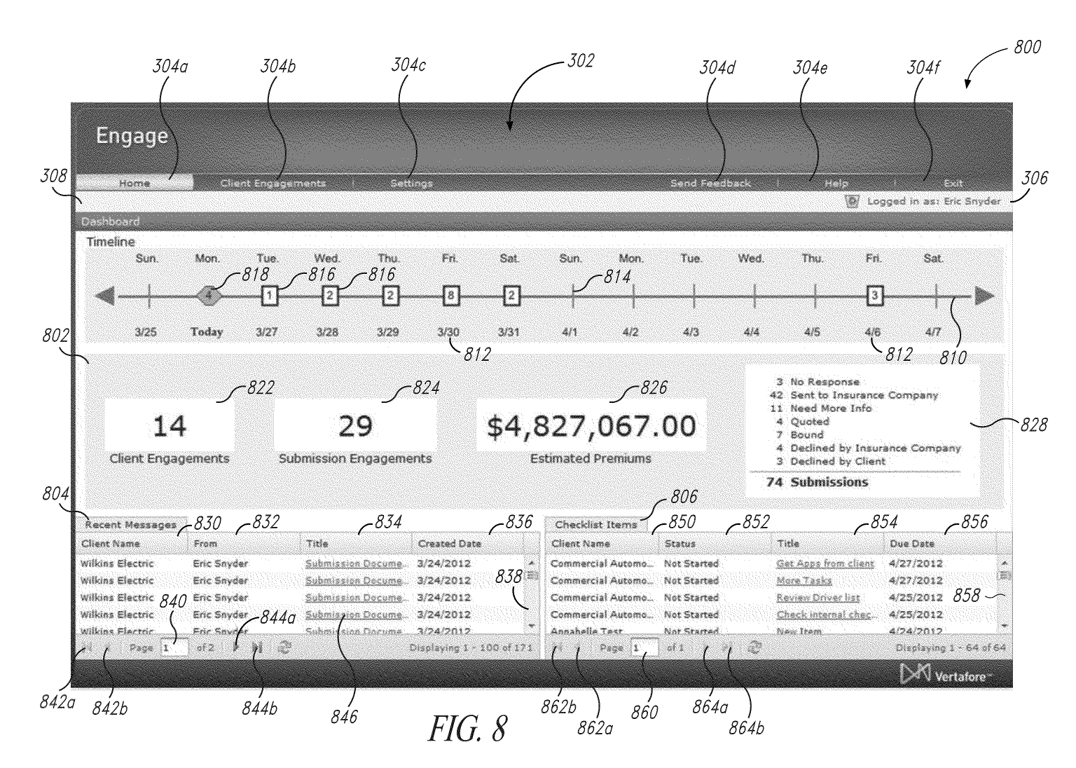

Selection of the home icon or tab 304a causes presentation of a dashboard panel that is discussed in greater detail with respect to FIG. 8. Briefly, selection of the home icon or tab 304a provides multiple panels within a single window. The panels may include a dashboard timeline panel summarizing incomplete tasks by date; a recent messages panel for reviewing, creating or transmitting electronic communications between the agent and an insurer or the agent and a consumer; and, a checklist items panel listing some or all of the outstanding incomplete tasks.

Selection of the send feedback icon or tab 304d causes presentation of a feedback panel (not shown), allowing the agent or broker to send, transmit, transfer or otherwise making available feedback to one or more intended recipients (e.g., to a vendor or support entity responsible for creation, maintenance, improvements and/or support of the insurance management system). Selection of the help icon or tab 304e causes presentation of a help panel or dialog box (not shown), allowing the agent or broker to enter a subject or topic of an inquiry regarding use of the insurance management system to receive help, assistance, or pointers. Selection of the exit icon or tab 304f causes an exiting of the insurance management system on the specific end user processor-based device.

Selection of the settings icon or tab 304c causes presentation of a settings screen 308 illustrated in FIG. 3. The settings screen 308 provides the agent, broker, or insurer with the ability to create, modify, or delete the tasks that are associated with one or more lines of business offered by the insurer. The settings screen 308 may be composed of a number of panels. In particular, the settings screen 308 may include an active engagements panel 310 and a task editing panel 312.

The active engagement panel 310 provides a set of selectable consumer or client icons 314 (shown collapsed in FIG. 3) which identify and correspond to a number of clients of the agency or brokerage. The set of consumer icons 314 displayed to any given end user (e.g., agent or broker), may be customized for the particular end user. In one example, the client icons 314 may identify each current or potential future client with whom the agency or brokerage has an existing relationship. In another example, the client icons 314 may identify each current or potential future client with whom the currently logged in user has an existing relationship. Although the list of client icons 314 is hidden in FIG. 3, selecting the expand/collapse icon (i.e., [symbol] , ▾) allows the toggling between presenting and hiding, respectively, the set of client icons 314.

The active engagement panel 310 also provides a set of selectable insurer or insurance company icons 316 (also shown collapsed in FIG. 3) which identify and correspond to a number of insurers with whom the agency or brokerage has an existing relationship. The set of insurance company icons 316 displayed to an agent or broker may be customized or otherwise limited. In one example, the insurance company icons 316 may identify each insurer that has an existing relationship with an agency or brokerage for which the particular end user works. This allows the agent or broker to more easily identify potential insurers from whom to solicit bids or policies. Although the list of insurance company icons 316 is hidden in FIG. 3, selecting the expand/collapse icon (i.e., [symbol] , ▾) allows the toggling between presenting and hiding, respectively, the set of insurance company icons 316.

Selection of a user selectable hide/show icon (i.e., <<) on the active engagements subpanel 310 toggles between presenting and hiding the active engagement panel 310. The active engagement panel 310 may additionally appear or be presented in other panels such as panels presented under the home icon or tab 304a or under the consumer engagement icon or tab 304b. In at least some instances, selecting an insurer from the insurance company icons 316 can cause an update of the content of the task editing panel 312. In one example, the line of business list provided in the task editing panel 312 is customized for each insurer by presenting only those lines of business provided by the selected insurer.

The task editing panel 312 includes a number of icons or tabs. In particular, the task editing panel 312 may include an agency details icon or tab 320, contacts icon or tab 322, integration icon or tab 324, managed insurance companies icon or tab 326, templates icon or tab 328, and import contacts icon or tab 330.

Selection of the templates icon or tab 328, for example using a pointing device or keyboard, brings up a templates panel 332, which includes a message template icon or tab 334 (shown unselected and hidden) and a checklist template icon or tab 336 (shown selected and active). When selected, the message template icon or tab 334 opens a window or screen containing various communications templates useful for corresponding with consumers, other agents, other brokers, and insurers.

Selection of the checklist template icon or tab 336 opens a checklist template window or screen containing columnar data. Although five data columns are displayed in FIG. 3, a greater or lesser number of data columns may be displayed as appropriate. Using the example provided in FIG. 3, the first data column provides an engagement type header 340 and includes data indicative of the party or parties at least partially responsible for completion of the associated task. The second data column provides a description header 342 and includes data indicative of a task description for the associated task. The third column provides a due date header 344 and includes data indicative of the formula used by the workflow management system 102 to calculate a calendar due date for the associated task. The fourth column provides an assigned to header 346 and contains data indicative of an individual or party assigned responsibility for completing the associated task. The fifth column provides a line of business header 348 and contains data indicative of the line of business associated with the task.

The engagement type text box 352 includes an engagement type drop down menu 352a (shown collapsed and not visible in FIG. 3). The engagement type provides an indication of the entity or entities (e.g., consumer, agency, broker, insurer, combinations thereof) engaged in and at least partially responsible for executing the associated task. A drop down button 352b (i.e., ▾) is provided to the right of the engagement type field. Clicking on the drop down button 352b opens the engagement type drop down menu 352a listing previously used and currently saved engagement types. The desired engagement type is selected from the drop down menu, for example by clicking with a mouse or similar pointing device. If a desired engagement type is not included in the engagement type drop down menu 352a, an input device such as a keyboard may be used to enter a new engagement type in the engagement type field. In some instances, “all” will be listed in the engagement type drop down menu 352a. Selecting “all” provides an input to the system indicative that all entities (e.g., consumer, agency or broker, and insurer) are engaged in and at least partially responsible for executing the associated task. In other instances, combinations (e.g., Agency & Insurance Company, Agency & Client, etc.) will be listed in the engagement type drop down menu 352a. Selecting a such a combination provides an input to the system indicative that the selected combination of entities are engaged in and at least partially responsible for executing the associated task.

The task description text box 354 includes a task description drop down menu 354 (shown collapsed and not visible in FIG. 3). The task description provides a brief summary or explanation of the associated task. In some instances, such tasks may involve one or more steps, activities, or actions performed by insurance professionals (e.g., task 370e, “Review vehicle losses”) without requiring input from the consumer. In other instances, such tasks may involve one or more steps, activities, or actions performed at least in part by the consumer (e.g., task 370b, “Review Driver list”). Each of the tasks forming the set of tasks associated with a particular line of business offered by the insurer generally require substantial completion to initiate, continue, update, or upgrade one or more insurance services provided to the consumer.

Although the system 102 automatically generates a set of tasks 370 associated with a particular line of business 372, at times, circumstances may require the addition of one or more tasks to the set of tasks or modification of one or more existing tasks associated with a particular line of business. Such instances may arise, for example, in response to new government regulations or insurance industry underwriting requirements. Such additions or modifications may be performed by an insurer, agent, or broker and may be populated throughout the system 102. For example, an insurer may add or amend one or more tasks to comply with an upcoming legislative deadline or one or more internal (e.g., underwriting) requirements. The insurer can add or amend the set of tasks associated with the line of businesses impacted and the system 102 will subsequently provide the corrected set of tasks to all brokers and agents affiliated with the insurer. Such capabilities advantageously enhance consistency in data provided by the various agents and brokers and reduce the time lost to obtaining additional information responsive to changes in internal or external conditions within the insurance industry. In another example, tasks related to one or more consumers may be altered or amended in the system 102 by an agent or broker. Such consumer specific task amendments or additions may advantageously improve the uniformity of coverage for a geographically diverse consumer such as a corporation, franchisor/franchisee, or extended family that resides in multiple broker or agent coverage areas.

The logged-in user 306 may enter such task modifications or new tasks in the description text box 354 using an input device such as a touchscreen or keyboard. The task description may be modified by selecting the task containing the description to be modified by clicking with a mouse or similar pointing device. Selecting the task will result in the data associated with the task being displayed in the respective text boxes 352, 354, 356, 358, 360, and 362. The data displayed includes the current description in the description text box 354. The text displayed in the description text box 354 may be modified and the modified description saved by clicking the update button 364.

Together the duration text box 356 and the trigger event text box 358 provide data useful in calculating a calendar due date usually based on the engagement due date for the respective task. Each engagement is assigned an engagement due date by the agent or broker. The calendar engagement due date can be based on many factors, and is typically based at least in part on an insurance service commencement date selected by the consumer. Each engagement also has an assigned engagement creation date. The engagement creation date is the calendar date the agent or broker enters the data into the system 102 creating the engagement.

Data in the duration text box 356 and the trigger event text box 358 combine to provide an input to the system that is indicative of a temporal duration in text box 358 and an input to the system that is indicative of a triggering event in the trigger event text box 358. Together the two pieces of data provide an indication of the temporal duration either precedent or subsequent to the triggering event at which the associated task should be substantially complete. Task due dates may therefore be of the form “X days before engagement due date” or “X days after engagement creation date,” where “X” represents a duration measured in days that is entered in the duration text box 356. The temporal duration data entered in the duration text box 356 indicative of a duration precedent to an engagement due date (i.e., “before engagement due date”) or subsequent to an engagement initiation date (i.e., “after engagement creation date”) at which point the associated task should be substantially complete.

The trigger event text box 358 includes a trigger event drop down menu 358a (shown collapsed and not visible in FIG. 3). A drop down button 358b (i.e., ▾, ▴) is provided to the right of the trigger event text box 358. Clicking on the drop down button 358b opens the trigger event drop down menu 358a listing all or a portion of the currently saved trigger event types. If a desired trigger event type is not included in the trigger event drop down menu 358a, an input device such as a keyboard may be used to enter data in the trigger event text box 358 that is indicative of a new trigger event type.

The assigned to text box 360 includes an assigned to drop down menu 360a (shown collapsed and not visible in FIG. 3). The assigned to text box 360 is used to provide an input to the system that is indicative of one or more individuals at least partially responsible for completing at least a portion of the associated task. A drop down button 360b (i.e., ▾, [symbol] ) is provided to the right of the assigned to text box 360. Clicking on the assigned to drop down button 360b opens the assigned to drop down menu 360a which lists the previously entered or currently saved individuals. Such individuals may include, for example, associates or employees of an insurance agency, brokerage, or insurer. If an individual is not included in the assigned to drop down menu 360a (e.g., a new employee or associate who has recently joined the agency or brokerage), an input device such as a touchscreen or keyboard may be used to provide an input to the system indicative of the new party or individual using the assigned to text box 360.

The line of business text box 362 includes a line of business drop down menu 362a (shown expanded in FIG. 3). The line of business drop down menu 362a is used to select from various insurance products or “lines of business” offered to consumers by the agency or brokerage. The various lines of business appearing in the line of business drop down menu may constitute insurance services or products offered by one or more insurers. A drop down button 362b (i.e., ▾) is provided to the right of the line of business text box 362. Clicking on the line of business drop down button 362b opens the line of business drop down menu 362a listing the available lines of business.

The available lines of business that appear in the line of business drop down menu 362a may depend on a variety of factors. For example, the lines of business listed in the line of business drop down menu 362a accessed by an agent will be those lines of business offered by a single insurer with whom the agency is affiliated. Conversely, the lines of business listed in the line of business drop down menu 362a accessed by a broker may include lines of business offered by multiple insurers with whom the brokerage is affiliated. Where the length of the line of business drop down menu 362b exceeds the screen height, a vertical scroll bar 362c is displayed permitting a system user to scroll through the entire line of business drop down menu 362b. If a desired line of business is not included in the line of business drop down menu 362a, an input device such as a touchscreen keyboard may be used to provide an input to the system indicative of a new line of business in the line of business text box 360.

Generally, selection of a particular line of business from the line of business drop down menu 362a results in the automatic or autonomous selection or generation of a set of tasks associated with the selected line of business by the workflow management system 102. Such sets of tasks may also be referred to as “checklist templates” since each task appearing in the set of tasks designates an element requiring substantial completion in order to provide one or more insurance services to the consumer. For example, selection of the “Business Automobile” line of business in the drop down menu 362a causes the system 102 to generate an output in the form of a set of tasks 370. The set of tasks 370 generated by the system 102 include: “Update Vehicle Schedule” 370a; “Review Driver List” 370b; “Check Auto ID Cards” 370c; “Check Internal Checklist” 370d; and “Review Vehicle Losses” 370e.

Providing inputs indicative of a particular consumer and indicative of one or more lines of business to associate the consumer may, in some instances, allow the system 102 to provide a set of tasks for each of the respective one or more lines of business that are selected to the specific needs of both the consumer and the insurer. For example, in some instances, the system 102 can provide a first set of tasks for the provision of a product or service for a corporate office in Minneapolis, Minn. (seismic zone 0), while a second set of tasks for the provision of the same product or service for the corporate office in Los Angeles, Calif. (seismic zone 4) includes the same tasks as the first set of tasks plus one or more earthquake related tasks. In such a manner, the system 102 can combine or otherwise correlate data from one or more inputs provided by the logged-on user 306 to provide sets of tasks that are generated at least in part based on: one or more insurer specific requirements or specifications, one or more agency or brokerage requirements or specifications, one or more consumer requirements or specifications, one or more federal, state, or local governmental requirements or specifications, one or more consumer industry specific requirements or specifications, or combinations thereof.

The set of tasks 370 output generated by the system 102 appears as a list with one task per line, displayed beneath a header 372 that indicates the line of business, a parenthetical line of business code, and a parenthetical task count associated with the line of business. Appearing to the left of the header 372 is a collapse/expand button 372a. The set of tasks 370 appearing in the task list beneath the header 372 may be alternatively displayed or hidden by clicking the collapse/expand button 372a. Once the set of tasks 370 appears as a task list beneath a header 372, each of the individual tasks 370a-e within the set of tasks 370 may be selected (e.g., by clicking with a mouse) and edited or modified (e.g., using a touchscreen, keyboard, or the like) via the text boxes 352, 354, 356, 358, and 360 as described in detail above.

To reflect the dynamic and evolving nature of insurance services, data appearing in any field, including engagement type, task description, due date, assigned to, or line of business may be modified, canceled, or deleted. For example, a task appearing within the set of tasks 370 associated with a particular line of business may be selected for modification by an agent, broker, or insurer. In one example, data related to the selected task may be altered or changed by the agent or broker to reflect a unique circumstance peculiar to a particular consumer. In such an instance, to provide an input to the system 102 indicative of a desire to store the entered data in the non-transitory storage medium, the logged-in user 306 can select the update button 364 using a touchscreen or mouse input. In another example, exigent circumstances may render a given task inappropriate for one or more consumers serviced by a particular agency or brokerage (e.g., a task involving a spouse of an unmarried individual). In such an instance, to provide an input to the system 102 indicative of a desire to remove or otherwise delete the data from the non-transitory storage medium, the logged-in user 306 can select the delete button 368 using a touchscreen or mouse input. Similarly, to provide an input to the system 102 indicative of a desire to not save or store the entered data in the non-transitory storage medium, the logged-in user 306 can select the cancel button 366 using a touchscreen or mouse input.

In some instances, one or more tasks not appearing in the task list may require completion to initiate, continue, update, or upgrade one or more insurance services. In such instances, new task data including the engagement type, task description, due date, and assigned to data may be added to the set of tasks by entering data into the appropriate text boxes 352-360 and clicking the add button 350.

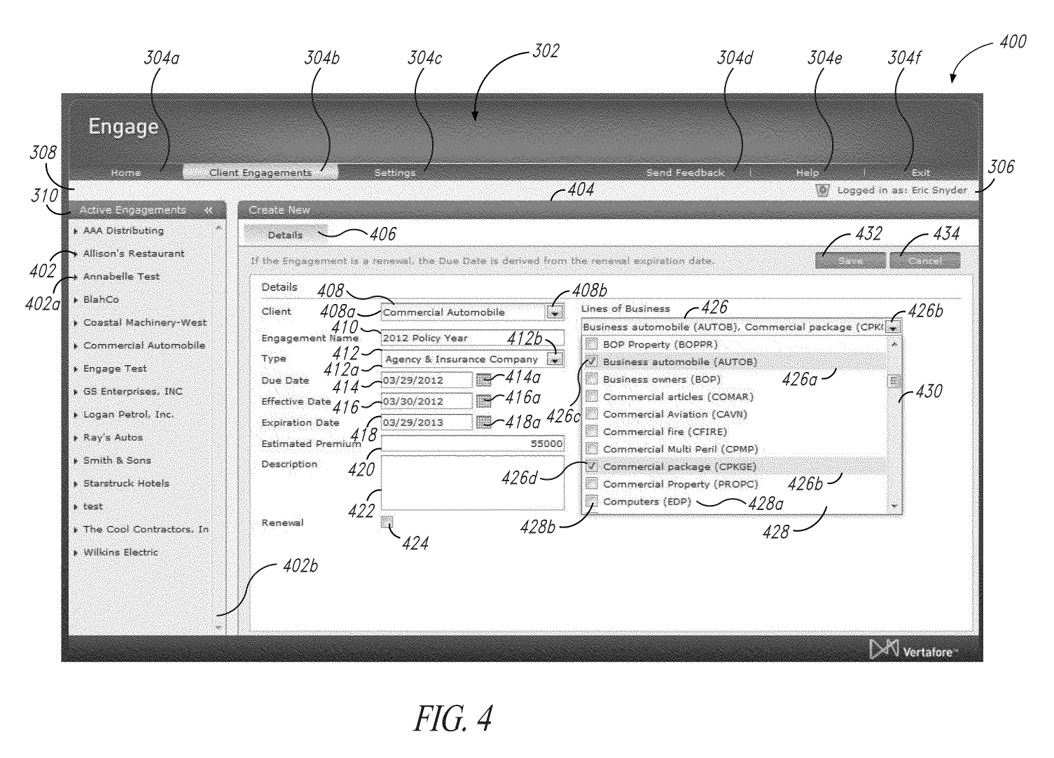

FIG. 4 shows a line of business selection provider interface 400 that is useful to an agent or broker for entering general consumer data and for associating one or more lines of business with a particular consumer. The line of business selection provider interface 400 is accessed by the agent, broker, or insurer by selecting the consumer or client engagement icon or tab 304b. The association of one or more lines of business with a consumer may, for example, be responsive to an inquiry from a potential new consumer or responsive to a service renewal request for an existing consumer. Upon entry of consumer data into the system 102, the consumer data is accessible and updatable by the agent, broker, or insurer. The ability to share consumer data between the agency or brokerage, and insurer can advantageously reduce the possibility of erroneous or absent information delaying or interrupting the provision of one or more insurance products or services to the consumer.

The association between a particular consumer and one or more lines of business may assist the agency or brokerage with planning, scheduling and executing the set of tasks 370 necessary to prepare one or more offers for insurance products or services for presentation to the consumer. In some situations, the system 102 may provide assistance in collecting or collating at least a portion of the data used in preparing an offer for one or more insurance products or services for a new or existing consumer. The system 102 can assist in collecting, organizing, and analyzing the data provided by the agency, brokerage or insurer to provide an accurate and timely offering that meets both the consumer's needs and schedule. The line of business selection provider interface 400 advantageously provides a convenient single collection point for entry of individualized consumer data and for selection of one or more lines of business, for example insurance products or services offered by one or more insurance carriers with whom the insurance agency or brokerage may have a relationship.

In some instances, the data provided on the line of business selection provider interface 400 may be stored in a non-transitory storage medium maintained locally by either the agency/brokerage or the insurance carrier. In other instances, the data provided via the line of business selection provider interface 400 may be stored in a non-transitory storage medium maintained remotely by a third party (i.e., cloud based data storage) that is accessible to the agent/broker and to the insurance carrier via one or more public or private local area networks (LANs), public or private wide area networks (WANs), Worldwide networks (Internet), or combinations thereof. The data entered on the line of business selection provider interface 400 is shared between the agency or brokerage and the insurer. In some instances, at least a portion of the data on the line of business selection provider interface 400 is not shared with or disclosed to the consumer.

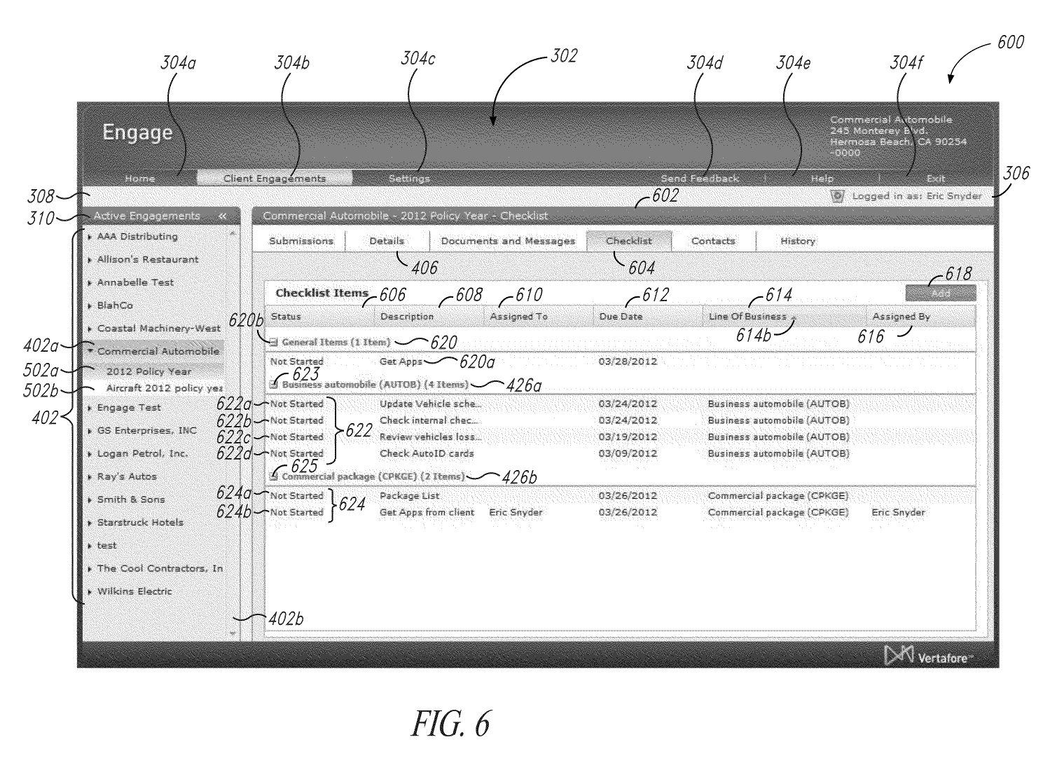

The line of business selection user interface 400 includes two panels, an active engagements panel 310 that includes a list of past, current, or future consumers 402 associated with a particular broker, agent, or insurer and a create new panel 404 that is used to associate one or more lines of business with one or more consumers 402. If the number of consumers exceeds the number that can be displayed within the active engagements panel 310, a slider bar 402b can be used to scroll upward and downward through the list of consumers 402. Selection of a particular consumer from the active engagements panel 310 opens an engagement checklist panel listing the lines of business associated with the consumer. Details of the engagement checklist panel are discussed in detail in FIG. 6.

The create new panel 404 includes a details tab 406 displaying a panel which allows inputs indicative of consumer specific information to the system 102 and in which one or more inputs indicative of one or more lines of business with which the consumer is associated are provided to the system 102. Within the details tab 406, an input indicative of the consumer is provided by the agent, broker, or insurer in text box 408. If the consumer has been previously entered or saved within the system, the drop down button (i.e., ▾, [symbol] ) 408b may alternatively be used to access a drop down list containing previously entered or saved consumers. Clicking on the consumer drop down button 408b alternatively opens and closes the consumer drop down list (not shown in FIG. 4). In at least some instances, the consumers listed in the consumer drop down list may be limited to or otherwise restricted to consumers associated with a particular agency, a particular brokerage, or to consumers associated with the individual agent or broker 306 currently logged on to the system 102. Alternatively or when adding a new consumer, an input indicative of the consumer name may be entered in the consumer text box 408 using an input device such as a touchscreen or keyboard.

An engagement name text box 410 is also provided within the details tab 406. The engagement name text box 410 permits an input to the system 102 that is indicative of an identifying word or phrase that is useful in summarizing or identifying the engagement. For example, in FIG. 4 the engagement name text box 410 contains an input indicative of the identifier “2012 Policy Year” that serves to distinguish this particular engagement from any other engagements that may be associated with the consumer “Client Automobile.” Also as shown in FIG. 4, two lines of business are selected for inclusion in the engagement “2012 Policy Year,” a business automobile line of business 426a and a commercial package line of business 426b.

An engagement type text box 412 is provided within the details tab 406. The engagement type allows an input to the system 102 that is indicative of one or more entities at least partially responsible for executing all or a portion of the tasks associated with providing the selected line(s) of business to the consumer or client. In the example shown in FIG. 4, the agency and the insurer have been indicated as being at least partially responsible for all or a portion of the tasks associated with the selected lines of business. If the engagement type has been previously entered or saved within the system, the drop down button (i.e., ▾, [symbol] ) 412b can be used to access a list containing the engagement types. Clicking on the engagement type down button 412b alternatively opens and closes the engagement type pull-down menu (not shown in FIG. 4) containing a list of entities (e.g., Agency, Brokerage, Insurer, or combinations thereof) who hold at least partial responsibility for executing the tasks associated with the provision of the insurance services.

An engagement due date text box 414 is provided within the details tab 406 to allow an input to the system 102 that is indicative of the due date upon which the tasks associated with providing the selected line(s) of business should be substantially complete. Generally, the engagement due date will precede the desired effective date of the policy by a defined number of calendar days (e.g., one to three calendar days) to provide the consumer with the opportunity to review the cost and details associated with the line of business. For example, if the desired effective date of the policy is Wednesday, Aug. 1, 2012, an engagement due date of Friday, Jul. 27, 2012 (i.e., three business days prior to the engagement effective date), may be input into the engagement due date text box 414 by the agent or broker. A calendar button 414a is provided adjacent to the engagement due date text box 414. Selecting the calendar button 414a opens a calendar pop-up window that contains a calendar having dates that when selected, for example by clicking on the date using a touchscreen or mouse, populate the engagement due date text box with the selected date.

An engagement effective date text box 416 is provided within the details tab 406 to allow an input to the system 102 that is indicative of the date upon which the insurance services indicated by the selected lines of business are provided to the consumer. In at least some instances, the engagement effective date is the date upon which the consumer becomes an insured. A calendar button 416a is again provided adjacent to the engagement effective date text box 416. Selecting the calendar button 416a opens a calendar pop-up window that contains a calendar having dates that when selected, for example by clicking on the date using a touchscreen or mouse, populates the engagement effective date text box with the selected date.

An engagement expiration date text box 418 is provided within the details tab 406 to allow an input to the system 102 that is indicative of the date upon which the insurance services indicated by the selected lines of business cease to be provided to the consumer. In at least some instances, the engagement expiration date is one at which point the consumer ceases being an insured (e.g., policy lapses). Engagements can be entered for any fixed time period from 1 day (i.e., expiration date 1 day after the effective date) to multiple years (e.g., expiration date 6 months or 1 year after the effective date). A calendar button 418a is again provided adjacent to the engagement expiration date text box 418. Clicking on the calendar button 418a opens a calendar pop-up window that contains a calendar having dates that when selected, for example by clicking on the date using a touchscreen or mouse, populates the engagement expiration date text box with the selected date.

An estimated premium text box 420 is provided within the details tab 406 to allow an input to the system 102 that is indicative of the expected premium charged the consumer to obtain the insurance services indicated by the selected lines of business 426a, 426b. The estimated premium entered in the text box 420 is for the policy effective period (i.e., the time period between the expiration date and the effective date). Amounts entered in the estimated premium text box may be in any currency. A description text box 422 is provided within the details tab 406 to provide an input to the system 102 that is indicative of any relevant notes or other information not explicitly obtained in other enumerated text boxes. The description text box can contain any additional, relevant, information provided by the agent, broker, insurer or underwriter.

A renewal check box 424 is provided within the details tab 406. Checking the renewal check box provides an input to the system 102 indicative of the engagement described in the details tab 406 is a renewal of a policy that is currently in effect for the selected consumer. Upon checking the renewal check box, the system 102 uses the current engagement expiration date to automatically calculate a new engagement expiration date.

The details tab 406 also contains a line of business text box 426 to provide an input to the system 102 that is indicative of the lines of business to associate with the consumer. Any number of lines of business may be associated with the consumer. For example, in FIG. 4 two lines of business are selected, a business automobile line of business 426a and a commercial package line of business 426b which have been selected by ticking the check boxes (i.e., □) 426c and 426d, respectively. Any number of lines of business may be associated with the consumer by ticking or otherwise selecting the check boxes corresponding to the line of business. Lines of business may also be entered directly into the lines of business text box 426, for example using an input device such as a touchscreen or keyboard. Alternatively, if one or more of the lines of business have been previously defined or saved within the system by an agent, broker, insurer, or underwriter, the lines of business drop down button (i.e., ▾) 426e may be selected to open a drop down list 428 containing the previously defined lines of business. The drop down list 428 contains each of the lines of business 428a along with a check box (□) 428b used to select the line of business with which it is associated. A slider bar 430 is used to scroll upward and downward through the lines of business drop down list.

Information entered in the details tab 406 can be saved or canceled by the user. To provide an input to the system 102 indicative of a desire to store the entered information in the non-transitory storage medium, the system user can select the save button 432 using a touchscreen or mouse input. To provide an input to the system 102 indicative of a desire to discard the entered information and to not store the entered information in the non-transitory storage medium, the system user can select the cancel button 434, for example using a touchscreen or mouse input.

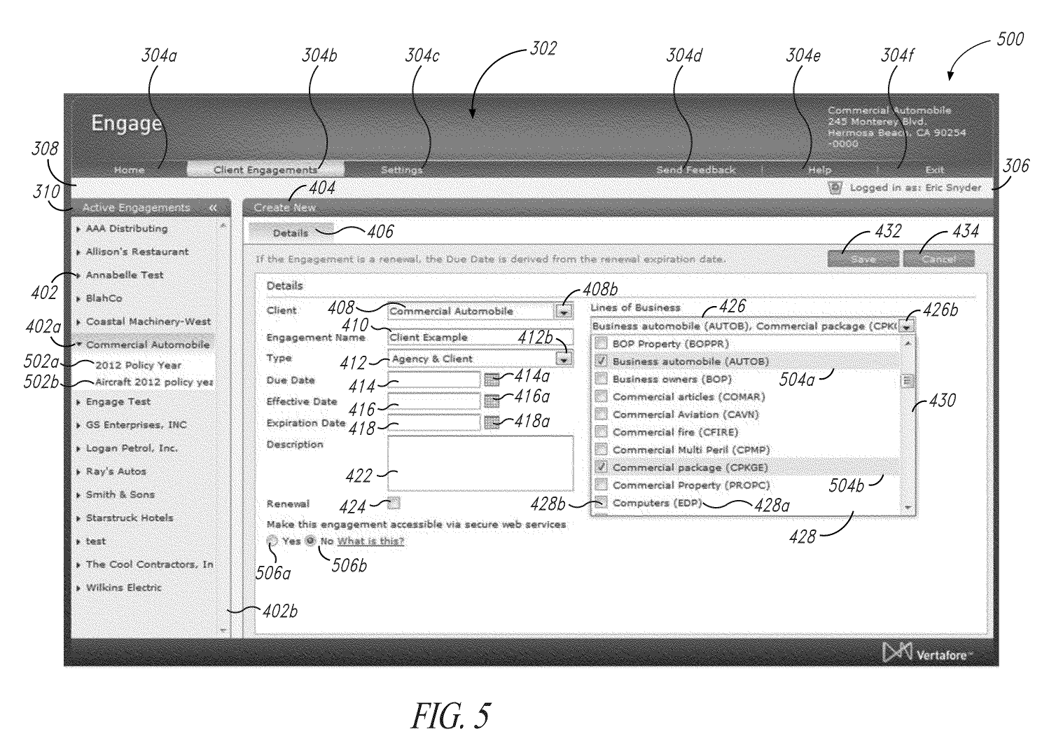

FIG. 5 shows a line of business selection consumer interface 500 that is particularly useful for providing input data to the system 102 that is indicative of one or more prospective or identified insurance product or service needs of the consumer. All or a portion of the line of business selection data entered on the line of business selection consumer interface 500 may be communicated between the agent or broker and the consumer, for example through the use of one or more public or private data networks such as the Internet.

The line of business selection consumer interface 500 provides for the entry of individualized consumer data, and for the selection of lines of business, for example insurance products or services offered by the insurer(s) with whom the broker or agent may have a relationship. In at least some instances the line of business selection consumer interface 500 advantageously provides a useful collaboration tool permitting a rapid and timely exchange of information or data between the agency or brokerage and the consumer. Such a tool can, for example, be used to facilitate the communication of tasks and similar data between the agent or broker and the consumer. Such task and data communication between the agent or broker and the consumer is useful in quoting, administering, amending, or otherwise providing one or more insurance services to the consumer.

In some instances, the data provided via the line of business selection consumer interface 500 may be stored in a non-transitory storage medium locally maintained by the agency, brokerage or insurer. In other instances, the data provided via the line of business selection consumer interface 500 may be stored in a non-transitory storage medium remotely maintained by a third party (i.e., cloud based data storage) that is accessible to the agent, broker, and consumer via one or more public or private local area networks (LANs), public or private wide area networks (WANs), Worldwide networks (Internet), or combinations thereof. In at least some instances, data entered on the line of business selection consumer interface 500 is shared between the consumer, the agent, the broker, and the insurer.

Clicking the drop down arrow (i.e., [symbol] , ▾) 402a adjacent “Commercial Automobile” provides a drop down list of the currently pending engagements associated with the consumer. For the consumer “Commercial Automobile,” two such existing engagements are listed: “2012 Policy Year” 502a and “Aircraft 2012 Policy Year” 502b. Referring to the details tab 406, “Client Example” is a new engagement that is being added to the two existing engagements already established for the consumer “Commercial Automobile.” In the line of business drop down list 428 two lines of business are indicated as being associated with the engagement “Client Example,” a business automobile line of business 504a and a commercial package line of business 504b.

In the line of business selection consumer interface 500, “Agency & Client” has been selected as the engagement type 412. The selection of “Agency & Client” shares the set of tasks associated with the business automobile line of business 504a and commercial package line of business 504b with both the insurance agency or brokerage and the consumer. Sets of tasks associated with the selected lines of business will be automatically added by the workflow management system 102 and access to those tasks is provided by the system to the consumer.

Yes/no radio buttons 506a and 506b, respectively, are provided on the details tab 406 to permit the agent or broker to provide an input to the system 102 indicative of a desire to share task and similar data with the consumer using one or more secure web services. Data transmitted or exchanged using a secure web service is encrypted or otherwise protected during communication using one or more security routines or algorithms. Using secure web services, the consumer is able to access the database containing, among other things, the set of tasks having an engagement type “Agency & Client” that are associated with the business automobile line of business 504a and the commercial package line of business 504b.

The entry of consumer data and the association of one or more lines of business with the consumer cause the system 102 to automatically generate a set of tasks 370 for each of the selected lines of business 504a, 504b. From the perspective of the agent or broker, these sets of tasks may in some instances be broken into two groups: a first group containing tasks at least partially resolvable between the agent or broker and one or more insurer, hereinafter referred to as an “agent/insurer” set of tasks; and a second group containing tasks at least partially resolvable between the agent or broker and the consumer, hereinafter referred to as an “agent/consumer” set of tasks.

In at least some instances, each of the tasks in the set of tasks may be apportioned based in whole or in part upon the entity or entities responsible for the substantial completion of the task. For example, FIG. 4 shows a provider interface that is shared between the insurance agency/broker and the insurer. At least a portion, though not necessarily all, of the tasks related to the lines of business (426a, 426b) selected on this screen are assigned to the agent or broker and the insurer. In a similar manner, FIG. 5 shows a consumer interface that is shared between the agent or broker and the consumer. At least a portion, though not necessarily all, of the tasks related to the lines of business (504a, 504b) selected on this screen are assigned to the agent or broker and the consumer.

FIG. 6 shows a provider task assignment screen 600 listing the various tasks forming the set of tasks associated with the line(s) of business selected on the line of business selection provider interface 400 and for which responsibility is at least partially shared between the agent or broker and the insurer. In at least some instances, the set of tasks associated with each of the selected lines of business 426a, 426b may be presented in checklist form as shown in FIG. 6. The provider task assignment screen 600 includes two panels, an active engagements panel 310 that includes a group of consumers 402 associated with a particular broker, agent, insurer, or underwriter and a checklist panel 602 providing the tasks within one or more sets of tasks in a row/column format. The provider task assignment screen displays only agent/insurer tasks.

The checklist panel 602 is accessed by clicking the checklist tab 604. The checklist tab 604 provides a set of tasks 622 associated with the business automobile line of business 426a and a set of tasks 624 associated with the commercial package line of business 426b. The checklist tab 604 provides a listing of the “agent/insurer” sets of tasks having an engagement type that in whole or in part identifies the “insurance company” in the engagement type field 412. In the example provided in FIG. 6, the checklist tab 604 displays a set of tasks 620 (comprising a single task, 620a) that is relevant to one or more general items associated with providing the insurance services to the consumer. The checklist tab 604 displays an agent/insurer set of tasks 622 (comprising 4 tasks, 622a-d) that is relevant to providing the business automobile line of business to the consumer. The checklist tab 604 finally displays an agent/insurer set of tasks 624 (comprising two tasks, 624a-b) that is relevant to providing the commercial package line of business to the consumer.

Each of the sets of tasks 620, 622, 624 includes a header stating the line of business, a parenthetical line of business code, and a parenthetical number of tasks for which agent/insurer responsibility has been designated in the engagement type field 412. FIG. 6 shows a single task 620a (“Get Apps”) listed under the general items header 620. An expand/collapse button 620b is shown to the left side of the general items header 620. In expanded mode, all of the tasks (a single task—620a) in the agent/insurer general items set of tasks are visible. In collapsed mode, the general items 620 header is visible and all of the tasks in the agent/insurer set of tasks are hidden. The expand/collapse button 620b provides a convenient way of displaying selected sets of tasks. As shown in FIG. 6, the set of tasks relevant to the general items header 620 is expanded, making visible the single agent/insurer task included in the set of tasks. Similarly, the set of four agent/insurer tasks 622a-d relevant to the business automobile line of business 426a is shown as expanded. Likewise, the set of two agent/insurer tasks 624a-b relevant to the commercial package line of business 426b is shown as expanded.

Expand/collapse buttons 620b, 623, 625 are shown to the left side of the general items header 620, the business automobile header 426a, and the commercial package header 426b, respectively. The expand/collapse buttons are used to expose the agent/insurer tasks in the sets of tasks relevant to each of the selected lines of business for the consumer. Selecting (e.g., clicking on) the expand/collapse button when the set of tasks is expanded causes the task list to collapse under the header, hiding the set of tasks. Selecting (e.g., clicking on) the expand/collapse button when the set of tasks is collapsed causes the task list to expand under the header, displaying the set of tasks.

Each set of tasks is arranged in a columnar format. Each task is detailed in a new row that is spread across six columns: a status column 606; a description column 608, an assigned to column 610; a due date column 612; a line of business column 614; and an assigned by column 616. A greater or lesser number of columns may be used to display task data on the provider task assignment screen 600.

The status column 606 is used by the system to provide an output indicative of the degree of completion of the associated agent/insurer task. Possible statuses may include, but are not limited to: “Not Started” indicating no progress has been reported by either the agent or insurer in completing the task; “In Process” indicating progress has been reported by either the agent or insurer, however the task has not yet reached a state of substantial completion; and “Complete” indicating sufficient progress has been reported by the agent or insurer to consider the task as being substantially complete. In some instances, the status may be manually updated by either the agent or insurer as progress is made towards task completion. In other instances, the status may be autonomously updated by the workflow management system 102 based on one or more inputs provided to the system 102 by either the agent or the insurer that is indicative of progress towards completion of the respective task.

The description column 608 is used to provide an extended description for each of the agent/insurer tasks listed in the set of tasks. The description provided in the description column 608 is provided from the description column 342 included in the line of business selection provider interface 300. If the description is modified or altered on the line of business selection provider interface 300, the modified or altered description will appear in the description column 608.

The assigned to column 610 is used to assign a party responsible for completing or tracking the completion progress at least a portion of the respective task. In the example shown in FIG. 6, the party “Eric Snyder” has been assigned to complete at least a portion of the agent/insurer task “Get Apps from Consumer” 624b. In at least some instances, assigning a party responsible to each task can facilitate the creation of agent/insurer task lists sorted by party responsible. Such party responsible agent/insurer task lists can advantageously assist in tracking the completion of any number of agent/insurer tasks across any number of lines of business for any number of consumers based on the party responsible for completing the tasks.

The due date column 612 provides a system calculated due date for each respective task. The due date displayed in the due date column 612 is a calendar date calculated by the system 102 using the data in the duration text box 356, the trigger event text box 358 (both provided as an input to the system 102 via the line of business update interface 300) and the data in the engagement due date 414 or engagement creation date (both provided as an input to the system 102 via the line of business selection provider interface 400).

For example, if the data entered in the due date column 344 on the line of business update interface 300 is “10 days before engagement due date” and the date entered in the due date field 414 on the line of business selection provider interface 400 is Apr. 30, 2012, the workflow management system would calculate the calendar due date by subtracting 10 days from the calendar date entered in the due date field 414. Consequently, Apr. 20, 2012 would appear as the due date for the respective task in the due date column 612. Other calendar due dates may be similarly calculated by the workflow management system 102 and displayed in the due date column 612 using the data entered in the due date column 344 and the appropriate calendar date (e.g., engagement due date entered in field 412 or engagement create date).

The line of business column 614 displays the line of business associated with each task. Note that tasks included in the agent/insurer set of tasks listed under the general items header 620 do not have an assigned line of business since such tasks apply to more than one line of business. A sort arrow 614b (i.e., ▴, ▾) is shown in the line of business column heading. Clicking on the line of business sort arrow 614b a first time will sort the tasks appearing in the checklist tab 604 in ascending alphabetic order by line of business. Clicking on the line of business sort arrow 614b a second time will sort the tasks appearing in the checklist tab 604 in descending alphabetic order by line of business.

The assigned by column 616 displays a data output generated by the system 102 that is indicative of the user entering the assigned to party responsible. In the example shown in FIG. 6, “Eric Snyder” is listed as the assigned by party who assigned task 624b to himself, thereby listing his name (“Eric Snyder”) as the assigned to party for task 624b. If, on the other hand “Eric Snyder” is logged into the system 102 and assigns one or more tasks to “Alan Farnsworth,” the name “Alan Farnsworth” would appear in the assigned to column 610 of the respective task and “Eric Snyder” would appear in the assigned by column 616 of the respective task. In some instances, the assigned to party may be limited, for example to individuals within a particular agency, brokerage, or insurer.

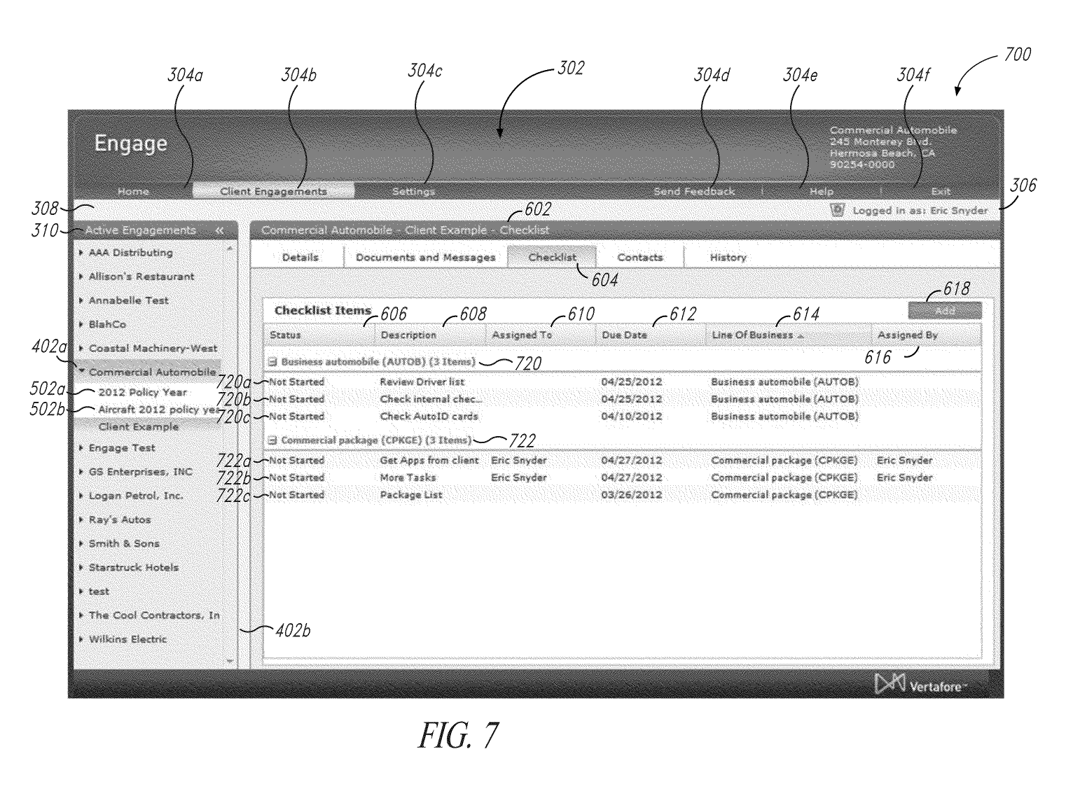

FIG. 7 shows a consumer task assignment screen 700 listing the various agent/consumer tasks forming the set of tasks associated with the lines of business selected on the line of business selection consumer interface 500 and for which responsibility is at least partially shared between the agent or broker and the consumer. In at least some instances, the set of tasks associated with each of the selected lines of business 720, 722 may be presented in checklist form as shown in FIG. 7. The consumer task assignment screen 700 includes two panels, an active engagements panel 310 that includes a group of consumers 402 associated with a particular broker, agent, insurer, or underwriter and a checklist panel 602 providing the agent/consumer tasks forming the one or more sets of tasks in a row/column format. The consumer task assignment screen 700 displays only agent/consumer tasks.

The checklist panel 602 is accessed by selecting (e.g., clicking) the checklist tab 604. The checklist tab 604 provides a set of agent/consumer tasks 622 associated with the business automobile line of business 504a and a set of agent/consumer tasks associated with the commercial package line of business 504b selected in FIG. 5. The checklist tab 604 provides a listing of the agent/consumer sets of tasks having an engagement type that in whole or in part identifies the consumer in the engagement type field 412. In the example provided in FIG. 7, the checklist tab 604 includes an agent/consumer set of tasks 720 (comprising 3 tasks, 720a-c) that is relevant to providing the business automobile line of business to the consumer. The checklist tab 604 also includes an agent/consumer set of tasks 722 (comprising 3 tasks, 722a-c) that is relevant to providing the commercial package line of business to the consumer.

Each of the sets of tasks 720, 722 includes a header stating the line of business, a parenthetical line of business code, and a parenthetical number of tasks for which agent/consumer responsibility has been designated in the engagement type field 412. Expand/collapse buttons 720d, 722d are shown proximate the left side of the respective headers 720, 722. Selecting (e.g., clicking on) on the expand/collapse button when the set of tasks is expanded causes the task list to collapse under the header, hiding the set of tasks. Selecting the expand/collapse button when the set of tasks is collapsed causes the task list to expand under the header, displaying the set of tasks. The expand/collapse buttons 720d, 722d provide a convenient way of hiding or displaying selected sets of tasks. As shown in FIG. 7, the set of three agent/consumer tasks 720a-c relevant to the business automobile line of business 504a is shown as expanded. Likewise, the set of three agent/consumer tasks 722a-c relevant to the commercial package line of business 504b is shown as expanded.

A set of tasks associated with each line of business is created, altered, or amended using the line of business update interface 300. One or more lines of business are selected by an agent, broker or insurer for each consumer based upon the identified insurance services needs of the consumer. The appropriate lines of business are selected using the line of business selection provider interface 400 and the line of business selection consumer interface 500. The selection of the one or more lines of business results in the workflow management system 102 automatically generating the set of tasks associated with each selected line of business. A portion of the tasks contained in each set of tasks relevant to the agent or broker and the insurer are designated “agent/insurer” tasks and are summarized by the system 102 using the provider task interface 600. A portion of the tasks contained in each set of tasks relevant to the agent or broker and the consumer are designated “agent/consumer” tasks and are summarized by the system 102 using the consumer task interface 700.

FIG. 8 shows an illustrative scheduling dashboard interface 800 that may be accessed by an agent, broker, insurer, or underwriter by selecting the home tab 304a. The scheduling dashboard interface 800 contains three panels, a timeline panel 802 showing a timeline and summary statistics for one or more lines of business; a recent messages panel 804 showing recent electronic communications between the agent or broker and the insurer, underwriter, or consumer; and a checklist items panel 806 showing various agent/insurer or agent/consumer tasks along with their respective task due dates. FIG. 8 thus advantageously provides a convenient “one stop shop” providing information relevant to pending agent/insurer and agent/consumer tasks associated with the lines of business provided by an agent or broker to one or more consumers.

The timeline panel 802 provides a timeline 810 including a scale comprising a series of calendar dates 812. The timeline 810 includes cross hatches 816 corresponding to each day represented by the timeline 810. The cross hatch 816 on days having one or more agent/insurer or agent/consumer tasks due are replaced by a system output comprising a user selectable icon 816 containing a number indicative of the number of agent/insurer or agent/consumer tasks due on that particular date. The user selectable icon 818 for the current date (i.e., “today's date”) may be visually distinguishable in shape, color, or combinations thereof. The timeline panel 802 may be customized for a particular user. For example, the timeline panel for an agent or broker contains task data for all tasks, including agent/insurer and agent/consumer since the agent or broker is at least partially responsible for those tasks. In contrast, the timeline panel 802 for an insurer or underwriter may include only agent/insurer tasks since agent/consumer tasks are not impacted by the insurer's activities.

In at least some instances, the timeline 810 is automatically generated by the workflow management system 102. Additionally, data included on the timeline panel 802 may be communicated to or otherwise transmitted or exchanged with one or more external systems or devices. For example, task data may be exported by the system 102 to an agent or broker's Outlook® calendar, Google® calendar, smartphone calendar application, or the like. In at least some instances, tasks due on the current day may generate an alarm indicative thereof using one or more external systems or devices such as an agent or broker's Outlook® calendar, Google® calendar, smartphone calendar application, or the like.

The timeline panel 802 includes a consumer engagements field 822 in which a current count of the number of successful consumer engagements is outputted by the system 102. Similarly, the timeline panel 802 includes a submissions engagements field 824 in which a current count of the number of successfully submitted engagements is outputted by the system 102. The timeline panel 802 includes an estimated premiums total field 826 in which the total of all consumer paid premiums based on the number of successfully completed consumer engagements is outputted by the system 102. The timeline panel 802 also includes a summary 828 that presents summarized disposition of each submitted engagement.

The scheduling dashboard interface 800 also includes a recent messages panel 804 in which inbound or outbound messages are displayed. The recent messages panel 804 can include a number of columns, including a consumer name column 830, from column 832, document title column 834, and created date column 836. The consumer name column 830 contains the name of the consumer associated with each respective electronic communication. The from column 832 indicates the originator of the respective electronic communication. The document title column indicates the subject of the respective electronic communication. In at least some instances, for example as shown in FIG. 8, the document title for each respective electronic communication may also serve as an HTML link to the document itself. Selecting the HTML link may open a new window containing the document associated with the selected document title. The created date column 836 indicates the creation date of the respective electronic communication.

A vertical slider bar 838 is provided to scroll upwards and downwards through the electronic communications listed in the recent messages panel 804. Navigation buttons including forward (i.e., [symbol] ) 844a, forward to end (i.e., [symbol] |) 844b, reverse (i.e., [symbol] ) 842a, and reverse to end (i.e., | [symbol] ) 842b may be used to navigate through the electronic communications listed in the recent messages panel 804. A page text box 840 may also be used to navigate through the electronic communications listed in the recent messages panel 804 by entering a desired page number in the page text box 840.

Such may allow an agent or broker to provide the content (e.g., text of message) of the correspondence, identify, attach or provide links to supporting electronic documents (e.g., spreadsheets, PDF documents, images), and specify intended recipients for the electronic correspondence. For example, where correspondence is a request for policy pricing, the correspondence may set out certain details of the policy (e.g., size, amount, length) and may attach one or more electronic documents related to the same request. The electronic documents may, for instance, provide data or information that supports the request.

The user interface may include one or more elements that allow the agent or broker to specify one or more subjects for the correspondence, for instance one or more lines of business to which the correspondence pertains. This may allow the system to automatically determine or identify intended recipients for the correspondence. For example, the system may identify all insurer underwriters that the particular agent or broker has an existing defined logical relationship and who handle the particular lines of business specified. In some instances, the system 102 can automatically store, classify, or associate correspondence with one or more consumers, agencies, brokerages, or insurers using one or more indicators appearing in the correspondence itself. Such indicators may include, but are not limited to, a correspondence subject line, keywords in the correspondence, the correspondence initiator, the correspondence recipient, the insurance product or service discussed in the correspondence, and the like.

The scheduling dashboard interface 800 also includes a checklist items panel 806 in which incomplete agent/insurer and agent/consumer tasks (i.e., agent/insurer and agent/consumer tasks having a status of other than “Completed”) are displayed. The checklist items panel 806 includes a number of columns, including a consumer name column 850, status column 852, title column 854, and due date column 856. The consumer name column 850 contains the name of the consumer associated with each respective incomplete task. The status column 852 indicates the status of the respective incomplete task. The title column indicates the respective task. In at least some instances, for example as shown in FIG. 8, the title for each respective task may also serve as an HTML link to the task itself. Selecting the HTML link may open a new window containing the task associated with the task selected in the checklist items panel 806. The due date column 856 indicates the autonomously generated due date for each of the listed incomplete tasks.

A vertical slider bar 858 is provided to scroll (e.g., upwards and downwards) through the tasks listed in the checklist items panel 806. Navigation buttons including forward (i.e., [symbol] ) 864a, forward to end (i.e., [symbol] |) 864b, reverse (i.e., [symbol] ) 862a, and reverse to end (i.e., | [symbol] ) 862b may be used to navigate through the incomplete tasks listed in the checklist items panel 806. A page text box 860 may also be used to navigate through the incomplete tasks listed in the checklist items panel 806 by entering a desired page number in the page text box 860.

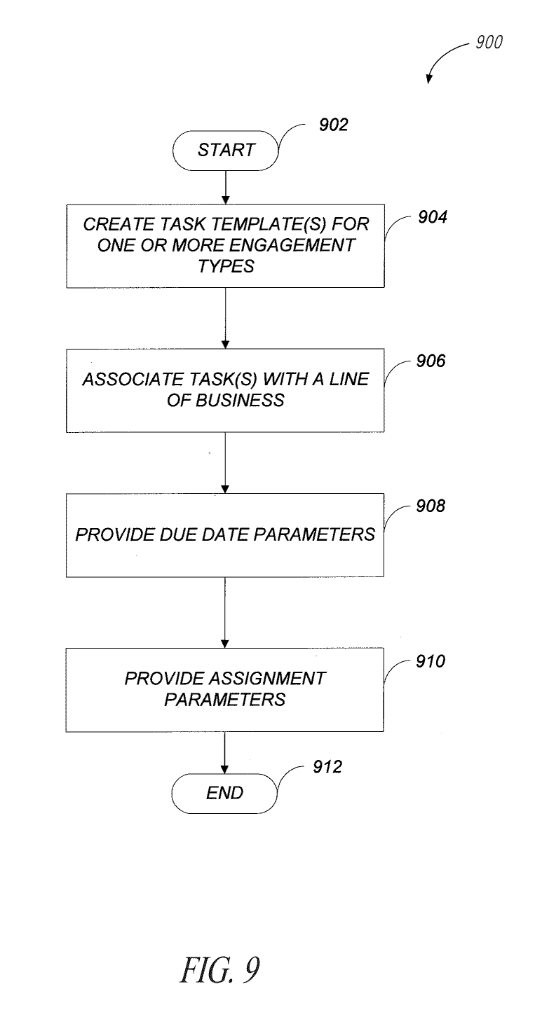

An illustrative example method 900 of an initial set-up and configuration of the workflow management system 102 is illustrated in FIG. 9. The system 102 permits the creation of a new task template or the modification of an existing task template associated with one or more lines of business by an agent, broker, or insurer. Task data may be created, added, or modified to provide a task template for a general type of engagement, or task data may be customized to address the particular needs or risks associated with a specific consumer or insured. Creation of task templates covering an engagement type can assist in ensuring the consistent and timely collection and delivery of information such as client information, risk information, and the like between the customer, the agent or broker, and the insurer or underwriter. The method commences at 902.

At 904, the system receives an input, for example from an agent, broker, or insurer, that creates one or more task templates for each engagement type. Tasks can include activities involving the customer, the agent/broker, the insurer, or any combination thereof. For example, a task template for a particular engagement may provide a first task for the agent to collect a customer's insured equipment information followed by a second task for the agent to forward the collected equipment information to the insurer. For example, where the customer is a construction company the engagement may include a first set of tasks containing tasks associated with the provision of insurance services for the customer's on-road construction equipment and a second set of tasks containing tasks associated with the provision of insurance services for the customer's off-road construction equipment. Sets of tasks may be further customized to address particular risk factors associated with the customer's particular or primary construction activity. Thus, for example a set of tasks associated with a vehicle used for off-road residential construction may differ from a set of tasks associated with a vehicle used for off-road logging or mining activities. At 904, such tasks may be entered into the system.

At 906, the system receives an input, for example from an agent, broker, or insurer to associate the task(s) entered at 904 with one or more lines of business. In some instances, the tasks may be associated with an existing line of business selected from the line of business drop down menu 362a. In other instances, the tasks may be associated with a new line of business added to the system. By associating the new or modified task(s) with one or more lines of business, the new or modified task(s) are included in the set of tasks associated with that particular line of business. Thus, any future selection of the particular line of business will result in the autonomous generation of a set of tasks including the new or modified task(s) added at 904 and associated with the line of business at 906.

At 908, the system receives an input, for example from an agent, broker or insurer, to provide one or more due date parameters associated with the task(s) entered at 904. Such due date parameters may include entry of data indicative of a duration value in the duration text box 356, and entry of data indicative of a trigger event in the trigger event text box 358. Thus, for example the due date for each entered task may be individually set based on a period of time (e.g., a number of days, weeks, or months, etc.) precedent or subsequent to a particular trigger event (e.g., before engagement due date, after engagement due date, etc.). By associating one or more due date parameters with the new or modified task(s), the system is able to provide both the parameters and a calculated calendar due date for each task included in the set of tasks. Provision of a calculated due date for each task advantageously permits the generation of system output indicative of the tasks requiring completion to provide one or more insurance related services to a customer or insured. Additionally, any future selection of the particular line of business will similarly result in the autonomous generation of a set of tasks that includes the new or modified task(s) added at 904, along with the calculated due date for each respective task based on the parameters entered at 908.

At 910, the system receives an input, for example from an agent, broker or insurer, to provide one or more assignment parameters associated with the task(s) entered at 904. Such assignment parameters may include entry of data indicative of one or more parties responsible for the completion of at least a portion of the task(s) entered at 904. Responsible parties may include, for example, the agent or broker with client contact, the agency or brokerage with client contact, the insurer, or combinations thereof. In some instances, tasks may be assigned to the customer or insured, for example to supply information that is only available to the customer or insured (e.g., personal information, vehicle identification numbers, etc.). Such tasks may be in the form of a ‘follow-up’ task assigned to the agent, broker, agency, or brokerage responsible for customer contact. By associating one or more assignment parameters with the new or modified task(s), the system is able to provide an assigned party responsible for at least partial completion of each task included in the set of tasks. Identification and memorialization of a party responsible for completion of each task advantageously permits the generation of output by the system for each party that provides guidance or a summary of the tasks assigned to the party. Additionally, any future selection of the particular line of business will result in the autonomous generation of a set of tasks by the system that includes the new or modified task(s) added at 904, along with the assigned party based on the parameters entered at 910. The method 900 ends at 912.

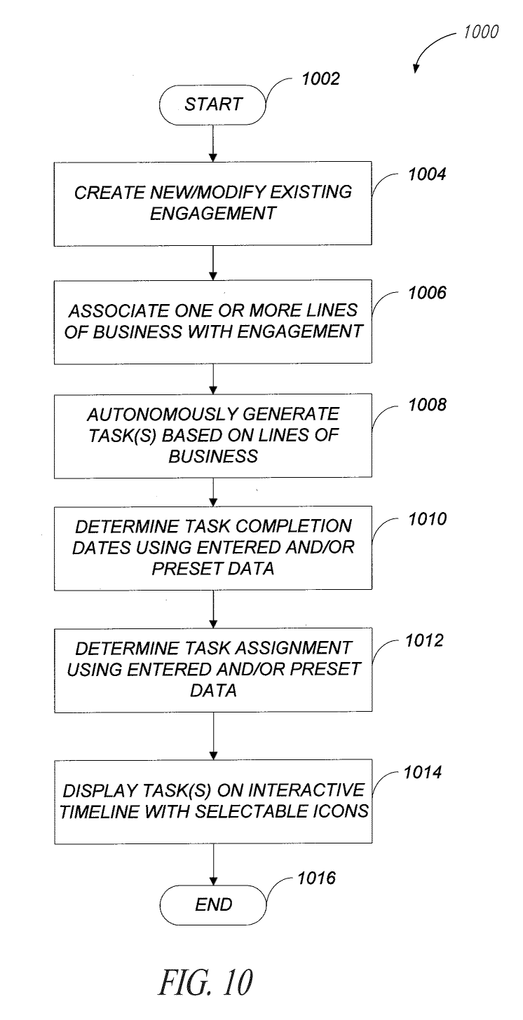

An illustrative method 1000 of operation of the workflow management system 102 is shown in FIG. 10. The system 102 permits the creation of a new engagement or the modification of an existing engagement for a customer or insured. Based on the selection of one or more lines of business for the engagement and the entry of customer or insured specific due date information, the system 102 can autonomously create one or more sets of tasks associated with the provision of one or more insurance services to the customer or insured. Calendar due dates autonomously calculated by the system 102 using due date parameters specific to each respective task may be associated with all or a portion of the tasks. Similarly, task assignments autonomously calculated by the system 102 using assignment parameters specific to each respective task may be autonomously assigned by the system 102 using the assignment parameters specific to each respective task. The system may further generate autonomous or on-demand output displaying such task data. In at least some instances, the output can include an interactive timeline including one or more user selectable icons that displays the various calculated calendar due dates for various tasks. Selection of the one or more user selectable icons can provide additional information specific to one or more tasks. The method 1000 commences at 1002.

At 1004, the system receives an input indicative of a proposed engagement for a prospective customer or an existing insured. Such input may be provided by a party in contact with the customer or insured, for example an agent or broker. The engagement may, for example, include provision of one or more insurance services to an individual consumer, a family, a commercial entity, an industrial entity, a municipal entity, or the like based on one or more identified or perceived needs for insurance services. Such an engagement may, in some instances, may be generated as a work product of an insurance needs analysis or similar conducted by an agent, broker, agency, brokerage, or insurer.

At 1006, the system receives an input, for example from an agent or broker that is indicative of the proposed lines of business that may be of interest or need to a consumer or insured party. Such lines of business may include in one example, auto, homeowners, and life insurance policies extended to an individual client. Such lines of business may include in another example, commercial auto and liability insurance policies extended to a commercial or industrial client. In at least some instances, lines of business are selected by the agent or broker based upon the identified insurance services needs or the express insurance service requirements of the consumer. As part of the line of business selection process, data indicative of one or more due dates, for example a potential customer's desired policy start date, may be entered by the agent or broker. Such due dates may include an engagement due date upon which all of the tasks in the set of tasks associated with the line of business should be substantially complete, an effective date of the insurance services, and an expiration date of the insurance services.

At 1008, based on the lines of business selected at 1006, the system 102 can autonomously generate one or more sets of tasks associated with each of the lines of business selected at 1006. Such sets of task may provide instruction or guidance on the steps useful in providing one or more insurance services to a customer or insured.

At 1010, the system 102 can generate a calendar due date for each task in the set of tasks associated with each line of business. Such due dates may be autonomously calculated by the system 102 based at least in part on the due date parameters provided when the task was entered or updated in the system 102, for example at 908. The due date parameters may include a number of days precedent the engagement due date or alternatively, a number of days subsequent the engagement creation date. Since the engagement creation date and the engagement due dates are known to the system 102, a calendar due date for each task may be automatically calculated by the system 102 at 1010.

At 1012, the system 102 can generate assignments for at least a portion of the tasks in the one or more sets of tasks associated with each line of business. Such assignments may be autonomously generated by the system 102 based at least in part on the assignment parameters provided when the task was entered or updated in the system 102, for example at 910. Each of the tasks in each of the respective sets of tasks may be designated, organized, or sorted based in at least in part on the parties responsible for contributing to the substantial completion of the task. For example, tasks completed by the agent, broker and insurer may be referred to as “agent/insurer” tasks, while tasks completed by the agent or broker and the consumer may be referred to as “agent/consumer” tasks. In at least some instances, tasks may be completed by the agent or broker, the consumer, and the insurer such tasks may be referred to as “agent/consumer/insurer” tasks.

The workflow management system 102 can group tasks from all of the sets of tasks associated with the selected lines of business to create an interactive timeline at 912. Timeline dates having upon which one or more task due dates fall may display a user selectable icon. In some instances, the user selectable icon can provide an indication of the number or types of tasks falling due on that date. A user, for example an agent, broker, or insurer can select a user selectable icon to open a window or panel displaying those tasks due on that particular date. The method 1000 concludes at 1016.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification including, but not limited to: U.S. application Ser. No. 13/451,168 filed on Apr. 19, 2012 in the names of Eric William Snyder, Lloyd Sutton Hawes II and Hon Seng Long and entitled “APPARATUS, METHOD AND ARTICLE TO AUTOMATE AND MANAGE COMMUNICATIONS TO MULTIPLE ENTITIES IN A NETWORKED ENVIRONMENT” (Atty. Docket No. 930140.408); U.S. application Ser. No. 13/451,136 filed on Apr. 19, 2012 in the names of Eric William Snyder, Steven Preston Finch, Hon Seng Long and Lloyd Sutton Hawes II and entitled “APPARATUS, METHOD AND ARTICLE TO AUTOMATE AND MANAGE ELECTRONIC DOCUMENTS IN A NETWORKED ENVIRONMENT” (Atty. Docket No. 930140.411); and, U.S. application Ser. No. 13/451,139 filed on Apr. 19, 2012 in the names of Eric William Snyder, Lloyd Sutton Hawes II, and Hon Seng Long and entitled “APPARATUS, METHOD AND ARTICLE TO AUTOMATE AND MANAGE COMMUNICATIONS IN A NETWORKED ENVIRONMENT” (Atty. Docket No. 930140.409) are incorporated herein by reference. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A method of operation of an insurance workflow management system including at least one processor, at least one nontransitory computer-readable medium communicatively coupled to the at least one processor, and a plurality of communications ports, the method comprising:
responsive to the receipt by the insurance workflow management system of an input indicative of a line of business selection, retrieving from the nontransitory computer-readable medium a set of tasks to create a line of business task list, at least a portion of the tasks in the set of tasks related to the provision of one or more insurance services;
responsive to the receipt by the insurance workflow management system of an input indicative of an insurance services engagement due date, calculating a respective due date for each task in the set of tasks, each of the respective due dates calculated using a respective time interval allocated for each task; and
autonomously generating by the insurance workflow management system an aggregate timeline including a plurality of user selectable icons, each user selectable icon corresponding to a calculated due date having one or more tasks falling thereupon.

2. The method of claim 1, further comprising:
responsive to the receipt by the insurance workflow management system of an input indicative of an icon selection input, generating a task summary output for those tasks having calculated due dates corresponding to the selected icon.

3. The method of claim 1 wherein calculating a respective due date for each task in the set of tasks includes:
calculating by the at least one processor the respective due date for each task using the respective time interval defined for the task and extending backwards from the received engagement due date, wherein the respective time interval allocated for the task includes an amount of time precedent to the engagement due date.

4. The method of claim 1 wherein calculating a respective due date for each task in the set of tasks includes:
calculating by the at least one processor a completion date preceding the received engagement due date by a defined number of calendar days; and
calculating by the at least one processor the respective due date for each task using the respective time interval defined for the task and extending backwards from the completion date, wherein the respective time interval allocated for the task includes an amount of time precedent to the completion date.

5. The method of claim 1 wherein calculating a respective due date for each task in the set of tasks includes:
calculating by the at least one processor the respective due date for each task using the respective time interval defined for the respective task and extending forward from an engagement creation date, wherein the respective time interval allocated for the task includes an amount of time subsequent to the engagement creation date.

6. The method of claim 1, further comprising:
receiving by the insurance workflow management system an input indicative of at least one new task;
logically associating by the insurance workflow management system the at least one new task with the selected line of business; and
storing in the nontransitory computer-readable medium the at least one new task and the logical association between the at least one new task and the selected line of business.

7. The method of claim 1, further comprising:
receiving by the insurance workflow management system an input indicative of a party responsible for at least a portion of at least one task in the set of tasks;
logically associating by the insurance workflow management system the respective at least one task with the party responsible; and
storing in the nontransitory computer-readable medium, the party responsible and the logical association between the respective at least one task and the party responsible.

8. The method of claim 7, further comprising:
receiving by the insurance workflow management system an input indicative of a request to generate a task list output by the party responsible; and
generating the task list output including a number of tasks grouped by the party responsible.

9. An insurance workflow management system for the generation of a line of business task list for the provision of one or more insurance services by an insurance agent, an insurance broker, an insurance underwriter, or an insurance carrier, the insurance workflow management system comprising:
at least one processor;
a plurality of communications ports communicably coupled to the at least one processor; and
at least one nontransitory computer-readable medium communicatively coupled to the at least one processor to provide the insurance workflow management system, wherein:
in response to an input by at least one of: the insurance agent, the insurance broker, the insurance underwriter, and the insurance carrier, that is indicative of the identification of a line of business, the at least one processor retrieves from the communicably coupled nontransitory computer-readable medium a set of tasks to create a line of business task list that is related to the provision of one or more insurance services;
in response to an input by at least one of: the insurance agent, the insurance broker, the insurance underwriter, and the insurance carrier, that is indicative of the identification of an insurance services engagement due date, the at least one processor calculates a respective due date for each task in the retrieved set of tasks, each of the respective due dates calculated using a respective time interval allocated for each task that is retrieved by the at least one processor from the communicably coupled nontransitory computer-readable medium;
in response to the calculation of the respective due dates for each of the tasks in the set of tasks, the at least one processor autonomously generates an aggregate timeline including a plurality of user selectable icons, wherein each user selectable icon corresponds to a calculated due date having one or more tasks falling thereupon; and
in response to a selection of a user selectable icon by at least one of: the insurance agent, the insurance broker, the insurance underwriter, and the insurance carrier, the at least one processor generates a task summary output including a group of tasks having calculated due dates corresponding to the selected icon.

10. The insurance workflow management system of claim 9 wherein the respective time interval allocated for the task includes an amount of time precedent to the engagement due date; and
wherein the at least one processor calculates the respective due date for each task by extending backwards from the received engagement due date by the amount of time at least equal to the respective time interval allocated for the task.

11. The insurance workflow management system of claim 9 wherein the respective time interval allocated for the task includes an amount of time precedent to a completion date;
wherein the at least one processor calculates the completion date by extending backwards a defined number of calendar days from the received engagement due date; and
wherein the at least one processor calculates the respective due date for each task by extending backwards from the completion date by the amount of time at least equal to the respective time interval allocated for the task.

12. The insurance workflow management system of claim 9 wherein the respective time interval allocated for the task includes an amount of time subsequent to an engagement creation date; and
wherein the at least one processor calculates the respective due date for each task by extending forwards from the engagement creation date by an amount of time at least equal to the respective time interval allocated for the task.

13. The insurance workflow management system of claim 9 wherein in response to the receipt of an input indicative of at least one new task, the at least one processor:
logically associates the at least one new task with the identified line of business; and
stores in the nontransitory computer-readable medium the at least one new task and the logical association of the at least one new task with the identified line of business.

14. The insurance workflow management system of claim 9 wherein in response to the receipt of an input indicative of a party responsible for at least a portion of at least one task in the set of tasks, the at least one processor:
logically associates the respective task with the party responsible; and
stores in the nontransitory computer-readable medium the party responsible and the logical association of the respective task with the party responsible.

15. The insurance workflow management system of claim 14 wherein in response to the receipt of an input indicative of a request to generate a task list output by the party responsible, the at least one processor;
autonomously generates a task list output including a number of tasks grouped by the party responsible.

16. An article of manufacture comprising a non-transitory, computer-readable, storage medium including instructions for an insurance workflow management system that when executed by at least one processor coupled to a non-transitory computer readable medium, cause the at least one processor to:
in response to the receipt by at least one processor of an input indicative of a line of business selection, retrieve from the nontransitory computer-readable medium a set of tasks related to the provision of one or more insurance services;
in response to the receipt by the at least one processor of an input indicative of an insurance services engagement due date, calculate a respective due date for each task in the set of tasks, each of the respective due dates calculated using a respective time interval allocated for each task;
autonomously generate an aggregate timeline including a plurality of selectable icons, each selectable icon corresponding to one calculated due date having one or more tasks falling thereupon; and
in response to the receipt by the at least one processor of an input indicative of an icon selection input, generate a task summary output for those tasks having calculated due dates corresponding to the selected icon.

17. The article of manufacture of claim 16 wherein the non-transitory, computer-readable, storage medium further includes instructions that cause the at least one processor to:
transmit via the one or more networks communicably coupled to the at least one processor the task summary output to at least one of: an insurance carrier, an insurance underwriter, an insurance broker, or an insurance agent.

18. The article of manufacture of claim 16 wherein the non-transitory, computer-readable, storage medium further includes instructions that cause the at least one processor to:
calculate the respective due date for each task using the respective time interval allocated for each task and extending backwards from the received engagement due date;
wherein the respective time interval allocated for the task includes an amount of time precedent to the engagement due date.

19. The article of manufacture of claim 16 wherein the non-transitory, computer-readable, storage medium further includes instructions that cause the at least one processor to:
calculate a completion date preceding the received engagement due date by a defined number of calendar days; and
calculate the respective due date for each task using the respective time interval allocated for each task and extending backwards from the completion date;
wherein the respective time interval allocated for the task includes an amount of time precedent to the completion date.

20. The article of manufacture of claim 16 wherein the non-transitory, computer-readable, storage medium further includes instructions that cause the at least one processor to:
calculate the respective due date for each task using the respective time interval allocated for each task and extending forward from an engagement creation date, wherein the respective time interval allocated for the task includes an amount of time subsequent to the engagement creation date.
